(19) United States
(12) Patent Application Publication
(10) Pub. No.: US 2026/0332804 A1
(43) Pub. Date: Oct. 22, 2026

(54) UNIFIED MOTION COMPENSATION FOR VIDEO CODECS

(71) Applicants: Hiu-Fai Ricky Chan, Rancho Cordova, CA (US); Huan Dou, London (GB); Kartik Dilip Raiker, Folsom, CA (US); Lidong Xu, Beijing (CN)

(72) Inventors: Hiu-Fai Ricky Chan, Rancho Cordova, CA (US); Huan Dou, London (GB); Kartik Dilip Raiker, Folsom, CA (US); Lidong Xu, Beijing (CN)

(21) Appl. No.: 19/692,860

(22) Filed: May 29, 2026

(51) Int. Cl. H04N 19/51; H04N 19/105; H04N 19/176; H04N 19/70

(52) U.S. Cl. CPC H04N 19/51; H04N 19/105; H04N 19/176; H04N 19/70

(57) ABSTRACT

Example systems, apparatus, articles of manufacture, and methods to perform unified motion compensation processing for multiple video codecs are disclosed. The disclosed subject matter provides unified motion compensation circuitry that supports multiple video codecs while reducing hardware requirements. The unified motion compensation circuitry includes shared cache and interpolation filter circuitry that processes reference pixel data to generate predicted pixel blocks for encoding and decoding operations. For example, the unified motion compensation circuitry identifies reference pixel data based on motion vector data and configuration data associated with an active video codec. The unified motion compensation circuitry then processes the reference pixel data using an active filter coefficient set selected based on the active codec standard from multiple stored filter coefficient sets associated with multiple supported coding standards.

### BACKGROUND

In video coding systems, motion compensation units process reference pixel data to generate predicted pixel data used in video encoder and video decoder operations. To encode a source block of pixel data of a current frame, a video encoder may employ motion compensation to (i) determine motion data, such as motion vector data, that shifts a reference block of pixel data decoded from a preceding frame to align with the source pixel block of the current frame, (ii) use the motion data to access the reference pixel block decoded from the preceding frame, and (iii) filter the reference block to generate a predicted block of pixel data for the source block that supports sub-pixel motion resolution. The video encoder may then encode the motion data and residual data that represents a difference between the source pixel block and the predicted pixel block as encoded data representing the source pixel block. To decode a block of pixel data from encoded data of a current frame, a video decoder may employ motion compensation to (i) use the encoded motion data to identify the appropriate reference block of pixel data decoded from the preceding frame, and (ii) filter the reference block to generate a predicted block of pixel data. The video decoder may then combine the predicted block and the encoded residual data to generate the decoded block of pixel data for the current frame. Such video encoding and decoding operations can achieve video compression because the motion data and residual data typically contain fewer bits than the source pixel block.

### BRIEF DESCRIPTION OF THE DRAWINGS

FIG. 1 is a block diagram of an example compute system including example unified motion compensation circuitry to implement unified motion compensation for video coding in accordance with teachings of this disclosure.

FIG. 2 is a block diagram of an example implementation of the unified motion compensation circuitry of FIG. 1.

FIG. 3 is a block diagram of an example horizontal filter circuitry and example vertical filter circuitry included in the example unified motion compensation circuitry of FIG. 2.

FIG. 4 illustrates example horizontal filtering operations performed by the example horizontal filter circuitry of FIG. 3.

FIG. 5 illustrates example vertical filtering operations performed by the example vertical filter circuitry of FIG. 3.

FIG. 6 is a block diagram of a second example implementation of the unified motion compensation circuitry of FIG. 2.

FIG. 7, which includes FIGS. 7A and 7B, is a block diagram of second example implementation of the horizontal filtering circuitry and the vertical filtering circuitry included in the example unified motion compensation circuitry of FIG. 6.

FIG. 8 illustrates an example reference pixel window stored in a reference pixel storage cache the example unified motion compensation circuitry of FIGS. 2 and/or 6.

FIG. 9 is a flowchart representative of example machine-readable instructions and/or example operations that may be executed, instantiated, and/or performed by example programmable circuitry to implement the unified motion compensation circuitry of FIGS. 2 and/or 6.

FIG. 10 is a flowchart representative of example machine-readable instructions and/or example operations that may be executed, instantiated, and/or performed by example programmable circuitry to implement reference pixel data retrieval in the example unified motion compensation circuitry of FIGS. 2 and/or 6.

FIG. 11 is a flowchart representative of example machine-readable instructions and/or example operations that may be executed, instantiated, and/or performed by example programmable circuitry to implement reference block filtering in the example unified motion compensation circuitry of FIGS. 2 and/or 6.

FIG. 12 is a flowchart representative of example machine-readable instructions and/or example operations that may be executed, instantiated, and/or performed by example programmable circuitry to configure the example unified motion compensation circuitry of FIGS. 2 and/or 6.

FIG. 13 is a block diagram of an example processing platform including programmable circuitry structured to execute, instantiate, and/or perform the example machine-readable instructions and/or perform the example operations of FIGS. 9-12 to implement the unified motion compensation circuitry of FIGS. 2 and/or 6.

FIG. 14 is a block diagram of an example implementation of the programmable circuitry of FIG. 13.

FIG. 15 is a block diagram of another example implementation of the programmable circuitry of FIG. 13.

FIG. 16 is a block diagram of an example software/firmware/instructions distribution platform (e.g., one or more servers) to distribute software, instructions, and/or firmware (e.g., corresponding to the example machine-readable instructions of FIGS. 9-12) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

FIG. 17 illustrates selection of an example reference pixel window by the unified motion compensation circuitry of FIGS. 2 and/or 6.

FIG. 18 illustrates an example alignment of fetched pixels with an interpolation filter as performed by the unified motion compensation circuitry of FIGS. 2 and/or 6.

In general, the same reference numbers will be used throughout the drawing(s) and accompanying written description to refer to the same or like parts. The figures are not necessarily to scale

### DETAILED DESCRIPTION

Motion compensation operations in video coding systems involve processing reference pixel data to generate predicted pixel data to represent source pixel data that was or is to be encoded. The difference, referred to as the residual, between the reference pixel data and the predicted pixel data is used as the basis for the resulting encoded data. As the residual data represents a difference between the reference pixel data and the predicted version of the source pixel data, the residual typically contains fewer bits than the original source pixel data, thereby achieving a compression efficiency.

Modern video coding systems support multiple video coding standards, such as a combination of the versatile video coding (VVC) standard, the high efficiency video coding (HEVC) standard, the Alliance for Open Media (AOMedia) video 1 (AV1) standard, and/or the video processing 9 (VP9) standard. Prior video coding systems utilize dedicated motion compensation units for the different video codecs implementing the different video coding standards. Each dedicated motion compensation unit includes dedicated filter circuitry, reference data storage caches and latency hiding structures for the associated video codec standard. Such hardware redundancy consumes substantial memory resources and yields excessive gate counts, which can impact device performance, power consumption, and manufacturing costs.

In contrast, example unified motion compensation circuitry disclosed herein implements a unified motion compensation architecture that supports multiple video codecs through a combination of shared circuitry components that implement motion compensation functions shared amongst the different video codecs, and distinct circuitry components that are dynamically configurable to implement codec-specific functions. Such a unified architecture can achieve substantial system benefits including reduced gate count, lower power consumption, reduced chip area, and improved processing efficiency for motion compensation operations across multiple video codecs relative to the prior video coding systems described above.

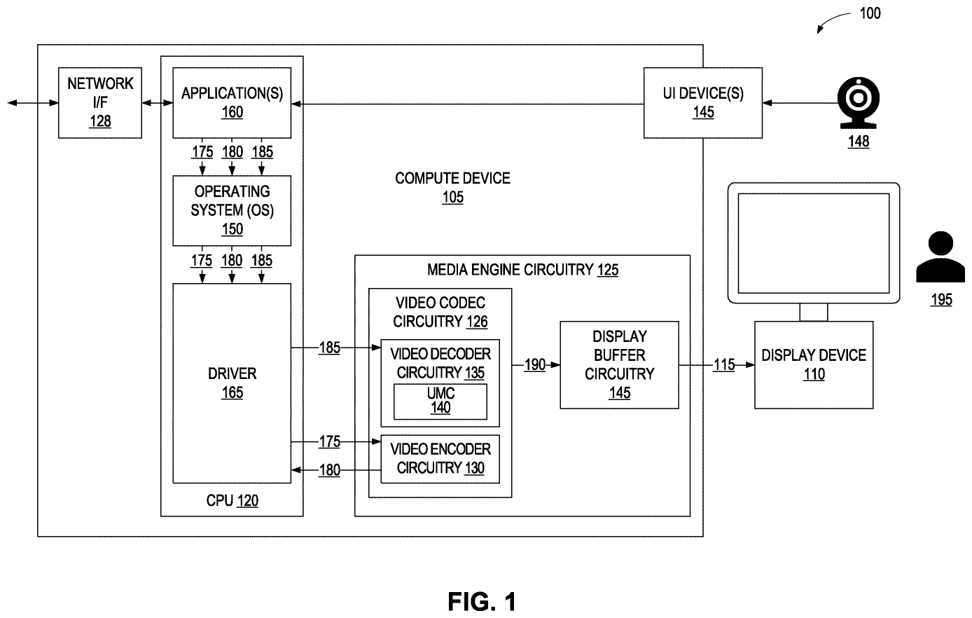

Turning to the figures, FIG. 1 is a block diagram of an example compute system 100 including example compute device 105 structured to implement unified motion compensation for video coding in accordance with teachings of this disclosure. The compute system 100 of FIG. 1 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSC), etc. Additionally or alternatively, the compute system 100 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

The example compute system 100 of FIG. 1 may be any type of compute system capable of generating and displaying image and/or video data. For example, the compute system 100 may be a personal computer, a notebook computer, a server, a smartphone, a media device, etc. The compute system 100 of the illustrated example can be deployed in various applications including video conferencing platforms, media streaming services, video editing tools, real-time video communication applications, etc. Such applications can benefit from efficient motion compensation processing by achieving high-quality video with low bandwidth utilization.

The compute system 100 includes the example compute device 105 and an example display device 110. The compute device 105 of the illustrated example can be any type of compute device capable of generating or otherwise providing image and/or video data to be displayed. For example, the compute device 105 may be a CPU, a GPU, a system board (e.g., a motherboard), a personal computer, a notebook computer, a server, a smartphone, a media device, etc. The display device 110 of the illustrated example may be any type of display device capable of displaying image and/or video data. For example, the display device 110 may be a computer monitor, a television, a touchscreen display, etc. In some examples, the compute device 105 and the display device 110 are separate devices (e.g., with separate housings, chassis, etc.). In some examples, the compute device 105 and the display device 110 are integrated into the compute system 100 (e.g., included in a same housing, chassis, etc.).

In the illustrated example system 100 of FIG. 1, the compute device 105 generates pixel data corresponding to a frame (e.g., a video frame, an image or an image frame, a digital picture, etc.) to be displayed by the display device 110, and sends the pixel data to the display device 110 via an example interface 115. The interface 115 of the illustrated example can be any type of interface capable of sending (e.g., transmitting) pixel data from the compute device 105 to the display device 110. For example, the interface 115 may be High-Definition Multimedia Interface (HDMI), DisplayPort (DP), Digital Visual Interface (DVI), Video Graphics Array (VGA), Universal Serial Bus (USB), etc., and/or any other wired and/or wireless interface, and/or combination thereof.

The compute device 105 of the illustrated example includes example central processing unit (CPU) circuitry 120, example media engine circuitry 125, example network interface circuitry 128, and one or more example user interface devices 145. The CPU 120 of the illustrated example includes (e.g., executes) an example operating system (OS) 150, one or more example applications 160 and an example driver 165 to interface between the CPU 120 and the media engine circuitry 125. The media engine circuitry 125 of the illustrated example includes example video codec circuitry 126 to perform video encoding and video decoding operations for the compute device 105. As such, the video codec circuitry 126 of the illustrated example includes example video encoder circuitry 130 to perform video encoding operations and example video decoder circuitry 135 to perform video decoder operations. The video decoder circuitry 135 also includes example unified motion compensation (UMC) circuitry 140 that implements unified motion compensation for video coding in accordance with teachings of this disclosure. The media engine circuitry 125 of the illustrated example further includes example display buffer circuitry 146 to implement a display buffer to store output frames 190 (e.g., output video frames, output images or image frames, output digital pictures, etc.) from the video codec circuitry 126 that are to be provided (e.g., sent, transmitted, etc.) to the display device 110 via the interface 115.

In the illustrated example, the user interface device(s) 145 of the compute device 105 include one or more of a mouse, a keyboard, a stylus, a touchscreen, etc., to allow an example user 195 of the compute device 105 to enter user input data to be processed by the compute device 105, such as user input data to be processed by one or more of the applications 160 executed by the compute device 105. In some examples, the user interface device(s) 145 also include an example camera 148 to capture image data, video data, etc., in the environment of the compute device 105. The camera 148 may be integrated into the compute device 105 (e.g., such as an integrated camera) or separate from but coupled to the compute device 105 (e.g., such as a separate camera accessory). In some examples, the camera 148 of the user interface device(s) 145 is positionable to capture camera data including images and/or video of the environment, which may include capturing images and/or video of the user 195.

The application(s) 160 of the illustrated example may include any application capable of generating, receiving, accessing or otherwise providing example encoded frames 185 (e.g., encoded video frames, encoded images or image frames, encoded digital pictures, etc.) to be decoded by the video codec circuitry 126 and, for example, presented by the display device 110, stored at the compute device 105, provided (e.g., transmitted) to a remote device, service, etc., via the network interface 128 circuitry, etc. For example, the application(s) 160 may include one or more video conferencing applications, one or more online meeting applications, one or more streaming media applications, etc., that may receive, access or otherwise obtain the encoded frames via the network interface 128 and/or any other source of encoded video frames, encoded images or image frames, encoded digital pictures, etc. The video codec circuitry 126 of the illustrated example may implement one or more video coding standards to decode the encoded frames 185 to produce the output frames 190 for presentation by the display device 110, storage at the compute device 105, transmission to a remote device, service, etc., via the network interface circuitry 128, etc., and/or for any other purpose.

The application(s) 160 of the illustrated example may additionally or alternatively include any application capable of generating, receiving, accessing or otherwise providing example unencoded source frames 175 (e.g., source video frames, source images or image frames, source digital pictures, etc.) to be encoded by the example video codec circuitry 126 to produce example encoded frames 180. For example, the application(s) 160 may include one or more video conferencing applications, one or more online meeting applications, one or more video creation applications, etc., that may receive, access or otherwise obtain the source frames 175 via the network interface 128, the camera 148, and/or any other source of unencoded source video frames, encoded images or image frames, encoded digital pictures, etc. The video codec circuitry 126 of the illustrated example may implement one or more video coding standards to encode the source frames 175 to produce the encoded frames 180 for storage at the compute device 105, transmission to a remote device, service, etc., via the network interface circuitry 128, etc., or any other purpose.

The network interface circuitry 128 of the illustrated example receives encoded video streams including the encoded frames 185 from external sources and provides them to one or more of the applications 160 of computing device 105. Additionally or alternatively, the network interface circuitry 128 of the illustrated example transmits encoded video streams including the encoded frames 180 from one or more of the applications 160 of the computing device 105 to external sources. In some examples, the network interface circuitry 128 processes network traffic according to networking protocols including but not limited to Transmission Control Protocol/Internet Protocol (TCP/IP), User Datagram Protocol (UDP), and Hypertext Transfer Protocol (HTTP). In some examples, the network interface circuitry 128 implements a Gigabit Ethernet interface with support for Quality of Service (QoS) features including traffic prioritization, flow control, and bandwidth management.

The driver 165 of the illustrated example provides the encoded frames 185 from one or more of the applications 160 to the media engine circuitry 125 for decoding by the video decoder circuitry 135. Additionally or alternatively, the driver 165 of the illustrated example provides the unencoded source frames 175 from one or more of the applications 160 to the media engine circuitry 125 for encoding by the encoder circuitry 130, and receives or otherwise obtains the resulting encoded frames 180 from the encoder circuitry 130 and provides the encoded frames 180 to one or more of the applications 160. The driver 165 of the illustrated example also controls the media engine circuitry 125, including the video encoding operations implemented by the video encoder circuitry 130 and the video decoding operations implemented by the video decoder circuitry 135. As such, in some examples, the driver 165 provides low-level access to the UMC circuitry 140 and/or other media processing components of the video encoder circuitry 130, the video decoder circuitry 135 and/or, more generally, the media engine circuitry 125. For example, the driver 165 may implement a device driver interface for the CPU 120 to configure and/or control operation of the video encoder circuitry 130, the video decoder circuitry 135 and/or, more generally, the media engine circuitry 125 (e.g., via one or more OS system calls, library calls, etc. made through the OS 150). In some examples, the device driver interface implemented by the driver 165 allows the CPU 120 to configure and/or control motion compensation operations implemented by the UMC circuitry 140 (e.g., via one or more OS system calls, library calls, etc. made through the OS 150).

The OS 150 of the illustrated example manages the resources of the computing device 105 and provides an execution environment for the application(s) 160. In some examples, the OS 150 includes a real-time operating system (RTOS) tailored for video processing operations. In the illustrated example, an active application 160 that obtains encoded frames 185 may provide the encoded frames 185 to the driver 165 via the OS 150 (e.g., via one or more OS system calls, library calls, etc.). Additionally or alternatively, in the illustrated example, an active application 160 that obtains unencoded source frames 175 may provide the source frames 175 to the driver 165 via the OS 150 (e.g., via one or more OS system calls, library calls, etc.) and obtain the encoded frames corresponding to the source frames 175 from the driver 165 via the OS 150 (e.g., via one or more OS system calls, library calls, etc.).

The media engine circuitry 125 of the illustrated example includes example video codec circuitry 126 to perform video encoding and video decoding operations for the compute device 105. As such, the video codec circuitry 126 includes the video encoder circuitry 130 to perform video encoding operations, and the video codec circuitry 126 includes the video decoder circuitry 135 to perform video decoding operations. In the illustrated example, the video codec circuitry 126 multiple video codecs supporting multiple video coding standards including one or more of HEVC, VP9, AV1, VVC, etc., and/or any other video coding standard(s). As such, the video decoder circuitry 135 implements a video decoder pipeline with support for multiple video coding standards including one or more of HEVC, VP9, AV1, VVC, etc., and/or any other video coding standard(s). Likewise, the video encoder circuitry 130 implements a video encoder pipeline with support for multiple video coding standards including one or more of HEVC, VP9, AV1, VVC, etc., and/or any other video coding standard(s).

In the illustrated example, the media engine circuitry 125 includes the UMC circuitry 140 to perform motion compensation for the multiple video codecs implemented by the video encoder circuitry 130 and the video decoder circuitry 135 of the video codec circuitry 126. In some examples, the UMC circuitry 140 is included in and implemented as part of the video decoder circuitry 135, but also accessible by the video encoder circuitry 130, as shown in FIG. 1. In some examples, the UMC circuitry 140 is implemented as stand-alone circuitry in the media engine circuitry 125 such that the UMC circuitry 140 is accessible by the video encoder circuitry 130 and the video decoder circuitry 135. As such, the video codec circuitry 126 utilizes the single unified motion compensation unit for multiple video coding standards, such as HEVC, VP9, AV1, VVC, etc.

For example, to encode a source frame 175 based on a given video coding standard, the video encoder circuitry 130 may employ the UMC circuitry 140 to determine motion data, such as motion vector data, that shifts a reference block of pixel data decoded from a preceding encoded frame produced by the video encoder circuitry 130 to align with a source pixel block of the source frame 175. The video encoder circuitry 130 may then employ the UMC circuitry 140 to use the motion data to access the reference pixel block decoded from the preceding frame. The video encoder circuitry 130 may further employ the UMC circuitry 140 to filter the reference block based on filter(s) selected according to the given video coding standard to generate a predicted block of pixel data for the source block that supports sub-pixel motion resolution. The video encoder circuitry 130 may then encode the motion data and residual data, which represents a difference between the source pixel block and the predicted pixel block, as encoded data representing the source pixel block in the encoded frame 180.

As another example, to decode an encoded frame 185 based on a given video coding standard, the video decoder circuitry 135 may employ the UMC circuitry 140 to obtain motion data for an encoded block of pixel data represented in the encoded frame 185 and use the motion data to identify the appropriate reference block of pixel data decoded from a preceding decoded frame produced by the video decoder circuitry 135. The video decoder circuitry 135 may then employ the UMC circuitry 140 to filter the reference block based on filter(s) selected according to the given video coding standard to generate a predicted block of pixel data. The video decoder circuitry 135 may then combine the predicted block and residual data obtained from the encoded frame 185 for the encoded block of pixel data being decoded to generate the corresponding decoded block of pixel data.

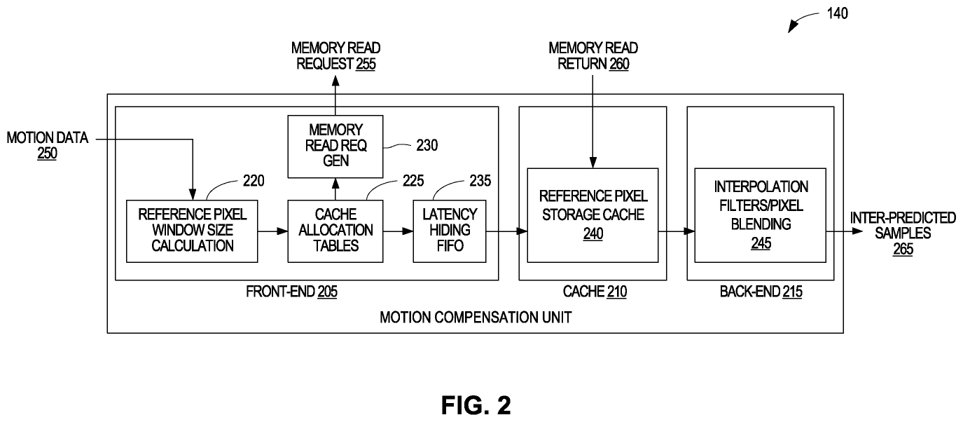

FIG. 2 is a block diagram illustrating an example implementation of the UMC circuitry 140 of FIG. 1. The UMC circuitry 140 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the UMC circuitry 140 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example UMC circuitry 140 of FIG. 2 includes example front-end circuitry 205, example cache circuitry 210, and example back-end circuitry 215. The front-end circuitry 205 of the illustrated example includes example window size calculation circuitry 220, example cache allocation table(s) 225, example memory read request generation circuitry 230, and example latency hiding buffer circuitry 235. The example back-end circuitry 215 of the illustrated example includes example interpolation filter circuitry 245.

The UMC circuitry 140 of the illustrated example operates on a reference block of pixel data, referred to as a reference pixel block, from a previously decoded frame of a given video sequence to generate a predicted block of pixel data, referred to as a predicted pixel block, to be used for video encoding and/or video decoding operations. The front-end circuitry 205 of the UMC circuitry 140, which is also referred to as reference data retrieval circuitry 205, is responsible for identifying a window of pixel data, referred to as a reference pixel window, including the reference pixel block to be processed, and retrieving the reference pixel window for further processing by the UMC circuitry 140. The reference pixel window includes the reference pixel block and surrounding pixels of the previously decoded frame to fill the cache lines of the cache.

The cache circuitry 210 of the UMC circuitry 140 is responsible for caching the reference pixel window. In the illustrated example, the cache circuitry 210 implements an example reference pixel storage cache 240. In some examples, the cache 240 may be configured to support variable cache line sizes, such as 8-byte lines, 16-byte lines, 32-byte lines, etc., and may include separate banks for different chroma subsampling formats. In some examples, the cache 240 may be implemented as a hierarchical structure with a small, low-latency L1 cache and a larger, higher-latency L2 cache to further reduce memory access delays.

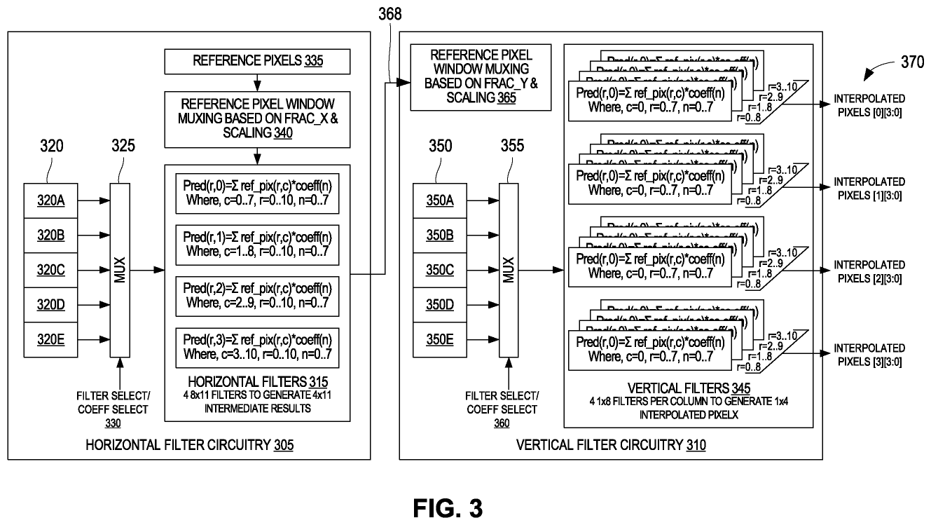

The back-end circuitry 215 of the UMC circuitry 140 is responsible for filtering the reference pixel block in the cached reference pixel window to generate and output an example predicted pixel block 265 of predicted samples for use in downstream video encoding operations and/or video decoding operations. The back-end circuitry 215 of the illustrated example includes the interpolation filter circuitry 245 to filter the reference pixel block based on filter(s) selected according to the particular video coding standard supported by the active video codec that will process the predicted pixel block 265. Further details concerning the interpolation filter circuitry 245 are provided below in the context of the description of FIG. 3.

To perform reference pixel window retrieval, the window size calculation circuitry 220 of the front-end circuitry 205 calculates the size and location of the reference pixel window based on the format of the reference pixel data, which is referred to as the reference surface format. The reference surface format may specify the chroma subsampling of the reference pixel, such as 4:2:0, 4:2:2, or 4:4:4 chroma subsampling, and pixel bit depth, such as 8-bit data or 10-bit data. The window size calculation circuitry 220 of the illustrated example also calculates the size and location of the reference pixel window based on a scaling factor. For example, some video coding standards, such as VP9, AV1 and VVC, support dynamic reference scaling in which the dimensions of the reference frame can be different than that of the current frame being processed. A scaling factor is used to scale the reference block position and motion vectors to locate the reference block in the reference image. For video coding standards, such as HEVC, that do not support this dynamic reference scaling, the scaling factor can be set to a value of 1 (or 1.0) to allow the window size calculation circuitry 220 to implement the same algorithm for any supported video coding standard.

In the illustrated example, the memory read request generation circuitry 230 of the front-end circuitry 205 then computes the physical addresses of the reference pixel window in memory based on the size and location information calculated by the window size calculation circuitry 220. For example, the memory read request generation circuitry 230 derives the cache-line addresses of the reference pixel window in the cache 240 based on the size and location information from the window size calculation circuitry 220 and information in the cache allocation table(s) 225, and translates the cache addresses into physical memory addresses of the memory in which the reference pixel window is stored. The memory read request generation circuitry 230 then generates an example memory read request 255 to retrieve the reference pixel window from memory based on the physical memory addresses. The requested reference memory window is then returned in an example memory read return 260, and the cache circuitry 210 of the illustrated example stores the retrieved reference memory window in the cache 240.

Because retrieving the reference pixel window from memory involves memory transactions, the performance of the UMC circuitry 140 is dependent on the overall memory transaction latency (e.g., such as memory-read latency). To address the latency and achieve satisfactory performance, the front-end circuitry 205 of the illustrated example includes the latency hiding buffer 235 to implement a latency hiding architecture that buffers memory read requests 255 for future reference pixel windows associated with future reference pixel blocks to be processed so the requests are available when the UMC circuitry 140 completes processing of the current reference pixel block. In some examples, the latency hiding buffer 235 implements a first-in-first-out (FIFO) buffer having a depth and width that are sized to accommodate a maximum memory read latency, a maximum memory round-trip latency, etc., of any supported video codec. For example, the FIFO width may be 144 bits and the depth may be 1000 cycles, ensuring that read requests can be queued without stalling the filter pipeline of the UMC circuitry 140.

The cache allocation tables 225 include information to identify the contents of the reference pixel storage cache 240. In some examples, the cache allocation table(s) 225 have associated cache allocation logic that determines whether a requested cache line is present or must be fetched from memory. For example, such cache allocation logic may implement least recently used (LRU) cache allocation in which the cache allocation logic accesses the cache allocation table(s) 225, compares the requested address with the least-recently-used entries and, if appropriate, evicts a line and fetches a new one. The table structure and gate count may be tailored to support a number of cache lines that satisfies the highest-performance video codec supported by the UMC circuitry 140.

FIG. 3 is a block diagram of an example implementation of the interpolation filter circuitry 245 of FIG. 2. The interpolation filter circuitry 245 of FIG. 3 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the interpolation filter circuitry 245 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

The interpolation filter circuitry 245 of FIG. 3 includes example horizontal filtering circuitry 305 and example vertical filtering circuitry 310 that include respective example configurable interpolation filters 315 and 345 along with codec-dependent coefficient selection mechanisms to perform reference pixel filtering in accordance with teachings of this disclosure. The configurable interpolation filters 315 of the horizontal filtering circuitry 305 of the illustrated example filter a reference pixel block in a horizontal direction (e.g., row-by-row) to determine horizontal filtered pixel data. The configurable interpolation filters 345 of the vertical filtering circuitry 310 of the illustrated example filters horizontal filtered pixel data in a vertical direction (e.g., column-by-column) to determine the resulting predicted pixel block from the reference pixel block. However, in some examples, the interpolation filter circuitry 245 can be structured to operate in a complementary manner in which the vertical filtering circuitry 310 filters the reference pixel block in a vertical direction (e.g., column-by-column) to determine vertical filtered pixel data, and then the horizontal filtering circuitry 305 filters vertical filtered pixel data in a horizontal direction (e.g., row-by-row) to determine the resulting predicted pixel block from the reference pixel block.

To configure the horizontal interpolation filters 315, the horizontal filtering circuitry 305 of the illustrated example includes example stored horizontal filter coefficient sets 320 associated with the different video coding standards supported by the UMC circuitry 140. In the illustrated example, individual ones of the stored horizontal filter coefficient sets 320 include a number of filter coefficients equal to the number of filter taps implemented by the horizontal interpolation filters 315. For example, each of the horizontal interpolation filters 315 may implement eight (8) taps and, as such, each of the stored horizontal filter coefficient sets 320 may include eight (8) coefficients to configure the respective taps of the horizontal interpolation filters 315. However, in some examples, each of the horizontal interpolation filters 315 may implement more or fewer than eight (8) taps and, as such, the stored horizontal filter coefficient sets 320 may include correspondingly more or fewer than eight (8) coefficients to configure the respective taps of the horizontal interpolation filters 315. In some examples, unused coefficients of a given stored horizontal filter coefficient set 320 can be set to zero to enable the horizontal interpolation filters 315 to implement filters having fewer than the total number of supported taps.

In some examples, the stored horizontal filter coefficient sets 320 are organized into one or more groups of stored horizontal filter coefficient sets 320 that are dedicated to particular ones of the different video coding standards supported by the UMC circuitry 140, and one or more groups of stored horizontal filter coefficient sets 320 that are shared among two or more of the different video coding standards supported by the UMC circuitry 140. For example, the stored horizontal filter coefficient sets 320 shown in FIG. 3 are organized into five example horizontal filter coefficient groups 320A-E. In the illustrated example, the horizontal filter coefficient group 320A includes one or more horizontal filter coefficient sets dedicated to the AVI coding standard. In the illustrated example, the horizontal filter coefficient group 320B includes one or more horizontal filter coefficient sets shared between the AV1 and VP9 coding standards. In the illustrated example, the horizontal filter coefficient group 320C includes one or more horizontal filter coefficient sets dedicated to the VP9 coding standard. In the illustrated example, the horizontal filter coefficient group 320D includes one or more horizontal filter coefficient sets dedicated to the VVC coding standard. In the illustrated example, the horizontal filter coefficient group 320E includes one or more horizontal filter coefficient sets shared between the VVC and HEVC coding standards.

Similarly, to configure the vertical interpolation filters 345, the vertical filtering circuitry 310 of the illustrated example includes example stored vertical filter coefficient sets 350 associated with the different video coding standards supported by the UMC circuitry 140. In the illustrated example, individual ones of the stored vertical filter coefficient sets 350 include a number of filter coefficients equal to the number of filter taps implemented by the vertical interpolation filters 345. For example, each of the vertical interpolation filters 345 may implement eight (8) taps and, as such, each of the stored vertical filter coefficient sets 350 may include eight (8) coefficients to configure the respective taps of the vertical interpolation filters 345. However, in some examples, each of the vertical interpolation filters 345 may implement more or fewer than eight (8) taps and, as such, the stored vertical filter coefficient sets 350 may include correspondingly more or fewer than eight (8) coefficients to configure the respective taps of the vertical interpolation filters 345. In some examples, unused coefficients of a given vertical stored filter coefficient set 350 can be set to zero to enable the vertical interpolation filters 345 to implement filters having fewer than the total number of supported taps.

In some examples, the stored vertical filter coefficient sets 350 are organized into one or more groups of stored vertical filter coefficient sets 350 that are dedicated to particular ones of the different video coding standards supported by the UMC circuitry 140, and one or more groups of stored vertical filter coefficient sets 350 that are shared among two or more of the different video coding standards supported by the UMC circuitry 140. For example, the stored vertical filter coefficient sets 350 shown in FIG. 3 are organized into five example vertical filter coefficient groups 350A-E. In the illustrated example, the vertical filter coefficient group 350A includes one more vertical filter coefficient sets dedicated to the AVI coding standard. In the illustrated example, the vertical filter coefficient group 350B includes one more vertical filter coefficient sets shared between the AV1 and VP9 coding standards. In the illustrated example, the vertical filter coefficient group 350C includes one more vertical filter coefficient sets dedicated to the VP9 coding standard. In the illustrated example, the vertical filter coefficient group 350D includes one more vertical filter coefficient sets dedicated to the VVC coding standard. In the illustrated example, the vertical filter coefficient group 350E includes one more vertical filter coefficient sets shared between the VVC and HEVC coding standards.

In the illustrated example, the active horizontal filter coefficient set 320 to be used to configure the horizontal interpolation filters 315 is selected from the stored horizontal filter coefficient sets 320 by example filter selection multiplexer circuitry 325 based on example input selection information 330 that may include an active codec identifier, an active filter type value, etc. In some examples, the input selection information 330 is written to a configuration register and/or other input interface by active dedicated video codec circuitry in the video codec circuitry 126. In some examples, the input selection information 330 is written to a configuration register and/or other input interface by the driver 165. For example, the multiplexer circuitry 325 may select the active horizontal filter coefficient set 320 from the horizontal filter coefficient group 320A when dedicated AVI video codec circuitry implementing the AVI video coding standard in the video codec circuitry 126 is active. As another example, the multiplexer circuitry 325 may select the active horizontal filter coefficient set 320 from the horizontal filter coefficient group 320B when dedicated AVI video codec circuitry implementing the AVI video coding standard or dedicated VP9 video codec circuitry implementing the VP9 video coding standard in the video codec circuitry 126 is active. As another example, the multiplexer circuitry 325 may select the active horizontal filter coefficient set 320 from the horizontal filter coefficient group 320C when dedicated VP9 video codec circuitry implementing the VP9 video coding standard is active. As another example, the multiplexer circuitry 325 may select the active horizontal filter coefficient set 320 from the horizontal filter coefficient group 320D when dedicated VVC video codec circuitry implementing the VVC video coding standard is active. As another example, the multiplexer circuitry 325 may select the active horizontal filter coefficient set 320 from the horizontal filter coefficient group 320E when dedicated VVC video codec circuitry implementing the VVC video coding standard or dedicated HEVC video codec circuitry implementing the HEVC video coding standard in the video codec circuitry 126 is active.

Similarly, in the illustrated example, the active vertical filter coefficient set 350 to be used to configure the vertical interpolation filters 345 is selected from the stored vertical filter coefficient sets 350 by example filter selection multiplexer circuitry 355 based on example input selection information 360 that may include an active codec identifier, an active filter type value, etc. In some examples, the input selection information 360 is written to a configuration register and/or other input interface by active dedicated video codec circuitry in the video codec circuitry 126. In some examples, the input selection information 360 is written to a configuration register and/or other input interface by the driver 165. For example, the multiplexer circuitry 355 may select the vertical horizontal filter coefficient set 350 from the vertical filter coefficient group 350A when dedicated AVI video codec circuitry implementing the AVI video coding standard in the video codec circuitry 126 is active. As another example, the multiplexer circuitry 355 may select the active vertical filter coefficient set 350 from the vertical filter coefficient group 350B when dedicated AVI video codec circuitry implementing the AVI video coding standard or dedicated VP9 video codec circuitry implementing the VP9 video coding standard in the video codec circuitry 126 is active. As another example, the multiplexer circuitry 355 may select the active vertical filter coefficient set 350 from the vertical filter coefficient group 350C when dedicated VP9 video codec circuitry implementing the VP9 video coding standard is active. As another example, the multiplexer circuitry 355 may select the active vertical filter coefficient set 350 from the vertical filter coefficient group 350D when dedicated VVC video codec circuitry implementing the VVC video coding standard is active. As another example, the multiplexer circuitry 355 may select the active vertical filter coefficient set 350 from the vertical filter coefficient group 350E when dedicated VVC video codec circuitry implementing the VVC video coding standard or dedicated HEVC video codec circuitry implementing the HEVC video coding standard in the video codec circuitry 126 is active.

In summary, the active filter coefficient set utilized by the interpolation filter circuitry 245 includes an active horizontal filter coefficient set 320 selected from one of the horizontal filter coefficient groups 320A-E and an active vertical filter coefficient set 350 selected from one of the vertical filter coefficient groups 350A-E. The active horizontal filter coefficient set 320 and the active vertical filter coefficient set 350 are applied to the horizontal interpolation filters 315 and the vertical interpolation filters 345, respectively. In some examples, one or more of the horizontal filter coefficient sets 320 and/or one or more of the vertical filter coefficient sets 350 may be generated dynamically from mathematical functions, allowing tap counts to vary across codecs. Such dynamic filter generation can reduce the amount of memory utilized for storing filter coefficients for multiple different video coding standards.

The horizontal filtering circuitry 305 of the illustrated example includes example reference pixel window multiplexing circuitry 340 to select example reference pixel samples 335 from the reference pixel window stored in the cache 240 and apply the reference pixel samples 335 to the horizontal interpolation filters 315 such that the filters process a given reference block of pixels, as described above. In the illustrated example, the reference pixel window multiplexing circuitry 340 selects the reference pixel samples 335 to align the appropriate reference samples associated with the given reference pixel block with the filter taps of the horizontal interpolation filters 315. For example, the reference pixel window multiplexing circuitry 340 may use the fractional horizontal and vertical components of the motion vector associated with the given reference pixel block to select the reference pixel samples 335 from the reference pixel window stored in the cache 240 such that the selected reference pixel correspond to the fractional position indicated by the motion vector.

As described above, the horizontal interpolation filters 315 of the illustrated example are configurable by the stored filter coefficient sets 320 to implement filters corresponding to different video codec standards. In the illustrated example, the horizontal interpolation filters 315 include four (4) filter circuits capable of filtering up to four (4) different rows of reference pixel data in parallel. However, in some examples, the horizontal interpolation filters 315 may include more or fewer than four (4) filter circuits capable of filtering up to a corresponding number of different rows of reference pixel data in parallel.

In the illustrated example, the horizontal interpolation filters 315 have a programmable hardware structure capable of implementing a configurable interpolation filter. In some examples, the configurable interpolation filter implemented by the horizontal interpolation filters 315 can be represented mathematically by Equation 1, which is:

P0=(A0*Coeff0)+(A1*Coeff1)+(A2*Coeff2)+(A3*Coeff3)+ . . . +(AN*CoeffN) Equation 1

In Equation 1, P0 is the interpolated pixel output by the horizontal interpolation filter 315, A₀ . . . A_{N} are the reference pixels being filtered, and Coeff₀ . . . Coeff_{N} are the filter coefficients corresponding to the selected horizontal filter coefficient set 320 that is active. In some examples, the configurable interpolation filter implemented by the horizontal interpolation filters 315 can be represented mathematically by Equation 2, which is:

for(int k=θ;k<xtaps;++k){|sum+=src_x[y*src_stride+(k−fo_horiz)*cStride]*xfilter[k];}sum=(sum+offset)>>shift; Equation 2

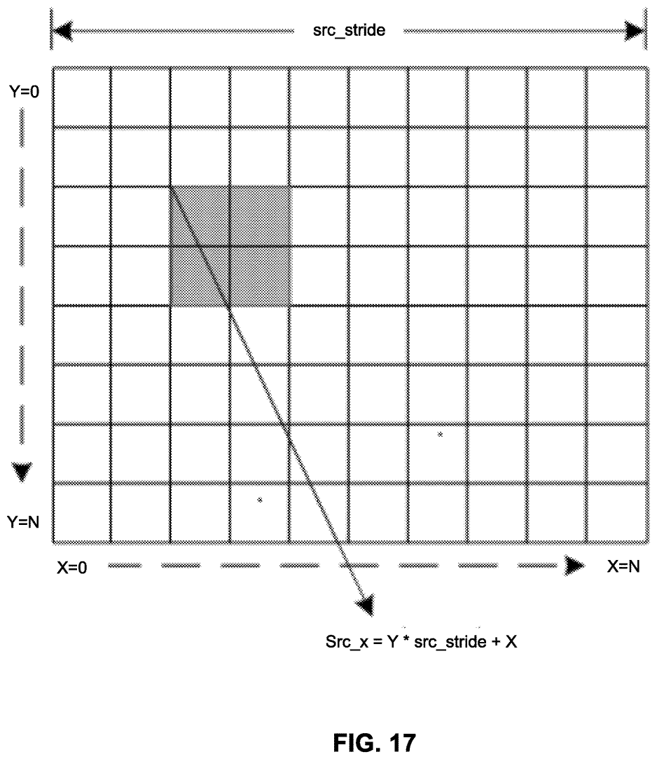

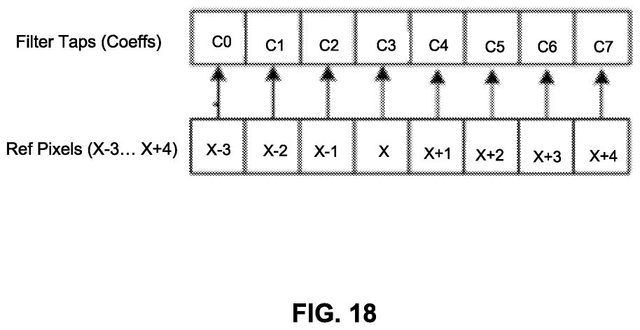

In Equation 2, a given horizontal interpolation filter 315 has a number of taps given by xtaps, and xfilter[k] represents the coefficient values of the filter taps, which are set based on the selected horizontal filter coefficient set 320 that is active. In Equation 2, src_x[ ] represents the reference pixel data being processed by the given horizontal interpolation filter 315. The variables y, src_stride, fo_horiz and cStride are set by the reference pixel window multiplexing circuitry 340 to select the appropriate reference pixel samples to be input to the horizontal interpolation filter 315 to result in filtering of a particular reference pixel block. In some examples, the variable y represents the Y-coordinate for the top-left pixel of the reference pixel window. In some examples, the variable src_stride represents the width of the reference picture buffer. In some examples, src_stride can be programmed to be wider than the actual frame width. In some examples, fo_horiz is a variable that is xtaps/2−1. For example, for an 8-tap filter, fo_horiz may be set to 3. As discussed above, to perform interpolation filtering using an 8-tap filter, we 3 pixels on the left of the current pixel and 4 pixels on the right of the current pixel are fetched in addition to the current pixel to align with the filter taps. FIG. 17 illustrates selection of an example reference pixel window by the reference pixel window multiplexing circuitry 340 based on the variables in Equation 2. FIG. 18 illustrates an example alignment of fetched pixels with an interpolation filter in accordance with Equation 2.

In some examples, the filter output of Equation 2 is also adjusted based on offset and shift parameters, which are codec-specific. Table 1 illustrates an example algorithm to determine the values of offset and shift depending on which of several supported video codecs is active

```
TABLE 1
if (codec_id == VP9)
{
  shift = FILTER_BITS;
  offset = (1 << FILTER_BITS) >> 1;
}
else if (codec_id == AV1)
{
  shift = ROUND0_BITS;
  offset = (1 << (bd + FILTER_BITS − 1)) + ((1 << shift) >> 1);
  if (isAV1WarpMotion) {
    shift = ROUND0_BITS + MAX(bd + FILTER_BITS − ROUND0_BITS − 14, 0);
    offset = (((1 << (shift)) >> 1));
  }
}
else // VVC and HEVC
{
  shift = bd + 6 − IF_INTERNAL_PREC;
  offset = −IF_INTERNAL_OFFS << shift;
}
```

In some examples, the variable FILTER_BITS in Table 1 represents the number of bits in the fractional portion of a filter coefficient. In some examples, FILTER_BITS is set to 7. For example, a coefficient value of 8′d128 (e.g., an 8-bit value of 10000000) would mean 1.0, with the 7 least significant bits representing 0. In some examples, after the dot product, the result is right-shifted by 7 bits with a rounding of 64 (e.g., corresponding to half-up rounding).

In some examples, the variable ROUND0_BITS in Table 1 is used in AV1 coding to perform two-stage rounding in which partial rounding is performed to keep extra precision for the vertical filter stage. In some examples, ROUND0_BITS is set to 3. For examples, after the horizontal stage, the result is partially rounded by ROUND0_BITS to keep extra precision for the vertical filter stage. In some examples, the result of vthe ertical filter stage is further rounded using (2*FILTER_BITS-ROUND0_BITS).

In some examples, the variable bd in table 1 defines the bit-depth (e.g., 8/10/12 bits).

In some examples, the variable IF_INTERNAL_PREC in Table 1 is set to 14. In some such examples, the equation “shift=bd+6−IF_INTERNAL_PREC” in Table 1 is a way to get “min (4,BitDepth-8)” as provided in HEVC/VVC coding. For examples, for a bit-depth of 10, both “shift=bd+6−IF_INTERNAL_PREC” and “min (4,BitDepth-8)” produce the result of 2.

In some examples, the variable IF_INTERNAL_OFFS in Table 1 is used as follows. In the case of VVC/HEVC coding, the horizontal filter output is normalized to a fixed 14-bit internal precision (e.g., specified by IF_INTERNAL_PREC). In that case, the shift bd+6-14 removes excess bits (e.g., the filter coefficients sum to 2\hat{ }6-64 in VVC/HEVC code, hence the value of 6). In some examples, the variable IF_INTERNAL_OFFS is set to −8192. The negative IF_INTERNAL_OFFS bias centers the intermediate signal around zero in signed representation, which is symmetric and useful for the subsequent vertical filtering. In some examples, this offset is undone after the vertical pass to recover unsigned pixel values.

The vertical filtering circuitry 310 of the illustrated example includes example reference pixel window multiplexing circuitry 365 to select example intermediate horizontal filtered pixel samples 368 from the outputs of the horizontal filters 315 and apply the horizontal filtered pixel samples 368 to the vertical interpolation filters 345 such that the filters implement filtering of a given reference block of pixels, as described above. In the illustrated example, the reference pixel window multiplexing circuitry 365 selects the appropriate horizontal filtered samples 368 to align with the filter taps of the vertical interpolation filters 345. For example, the reference pixel window multiplexing circuitry 340 may use the fractional horizontal and vertical components of the motion vector associated with the given reference pixel block to select the appropriate horizontal filtered pixel samples 368 from the outputs of the horizontal filters 315 such that the selected horizontal filtered pixel samples 368 correspond to the fractional position indicated by the motion vector.

As described above, the vertical interpolation filters 345 of the illustrated example are configurable by the stored filter coefficient sets 350 to implement filters corresponding to different video codec standards. In the illustrated example, the vertical interpolation filters 345 include four (4) filter circuits capable of filtering up to four (4) different columns of horizontal filtered pixel data in parallel. However, in some examples, the vertical interpolation filters 345 may include more or fewer than four (4) filter circuits capable of filtering up to a corresponding number of different columns of reference pixel data in parallel. In the illustrated example, the vertical interpolation filters 345 have a programmable hardware structure capable of implementing a configurable interpolation filter similar to the filters represented mathematically by Equation 1, Equation 2 and/or Table 1 (but with the horizontal filter and data variables in those equations replaced with corresponding vertical filter and data variables associated with the vertical interpolation filters 345). The filtered output data produced by the vertical interpolation filters 345 form an example predicted pixel block 370 that can be used for downstream video codec processing.

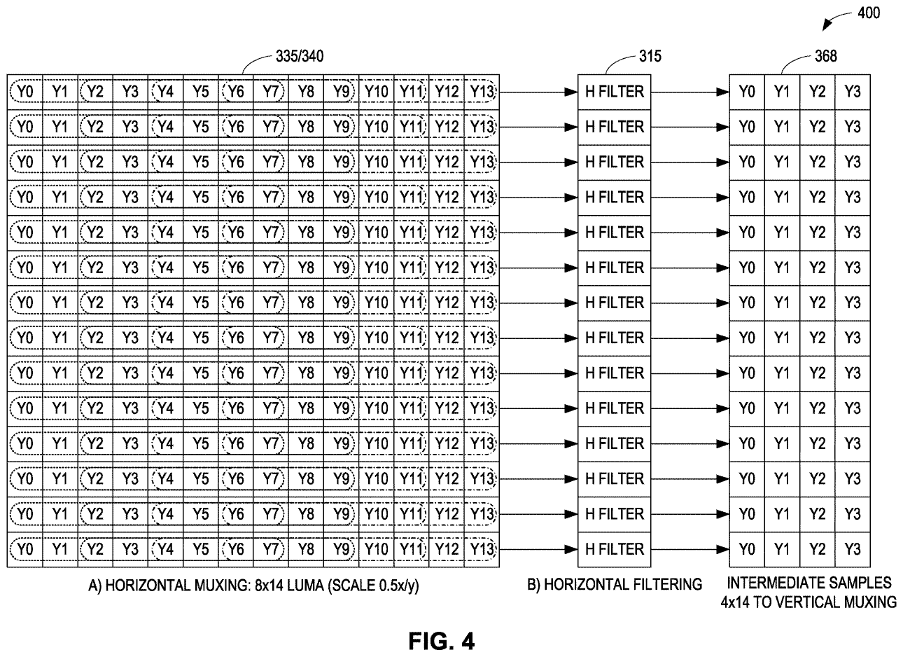

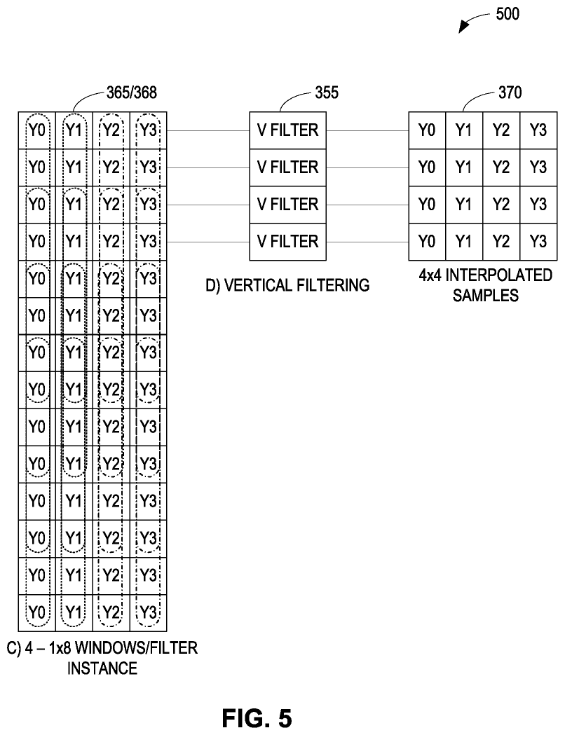

FIGS. 4 and 5 illustrate example filtering operations performed by the example interpolation filter circuitry 245 of FIG. 3. More specifically, FIG. 4 illustrates example horizontal filtering operations 400 performed by the example horizontal filtering circuitry 305 in the interpolation filter circuitry 245 of FIG. 3, and FIG. 5 illustrates example vertical filtering operations 500 performed by the example vertical filter circuitry 310 in the interpolation filter circuitry 245 of FIG. 3.

Turning to FIG. 4, the horizontal filtering operations 400 begin with the reference pixel window 335 being selected by the reference pixel window multiplexing circuitry 340. The size of the reference pixel window 335 depends on the size of the reference pixel block to be filtered, the number of filter coefficients/taps implemented by the horizontal interpolation filters 315 and whether dynamic scaling of the reference data is being performed by the active video codec. As described above, dynamic reference scaling allows the dimensions of the reference frame to be different than that of the current output frame being generated by the video codec circuitry 126. For example, if dynamic reference scaling with a scale factor of 0.5 is enabled, the output frame will be downscaled to half the size of the reference frame.

Thus, the reference pixel window multiplexing circuitry 340 uses the predicted pixel block size to be produced from the reference pixels, the number of filter coefficients/taps and the dynamic scaling scale factor to select the appropriate window of reference pixel data 335 to be provided to the horizontal interpolation filters 315. In the illustrated example, the predicted pixel block size is 4×4 pixels, the number of filter taps is 8, and the scale factor is 0.5. As a result, the reference pixel window multiplexing circuitry 340 selects the reference pixel window 335 to be 14×14 pixels, as shown, to enable four (4) predicted pixel positions in the horizontal and vertical directions to be generated with 8-tap filters and with a stride of 2 corresponding to the scale factor of 0.5 (e.g., 8 filter taps+0 pixel shift for filtering the first of 4 pixel positions+2 pixel shift for filtering the second of 4 pixel positions+2 pixel shift for filtering the third of 4 pixel positions+2 pixel shift for filtering the fourth of 4 pixel positions=14 pixels). As another example, for a scale factor of 1.0 corresponding to no scaling, the reference pixel window multiplexing circuitry 340 would select the reference pixel window 335 to be 11×11 pixels to enable four (4) predicted pixel positions in the horizontal and vertical directions to be generated with 8-tap filters and with a stride of 1 corresponding to the scale factor of 1.0 (e.g., 8 filter taps+0 pixel shift for filtering the first of 4 pixel positions+1 pixel shift for filtering the second of 4 pixel positions+1 pixel shift for filtering the third of 4 pixel positions+1 pixel shift for filtering the fourth of 4 pixel positions=11 pixels).

In the horizontal filtering operations 400, the horizontal interpolation filters 315 then filter each row of the reference pixel window 335 to produce the example intermediate horizontal filtered pixel data 368 described above. The ovals illustrated in each row of the reference pixel window 335 identify the subsets of reference pixels to be filtered with each shift of the horizontal interpolation filters 315 across the row. In the illustrated example, each shift has a stride of 2 pixel positions corresponding to the scale factor of 0.5. In the illustrated example, horizontal filtering operations 400, the horizontal interpolation filters 315 are each configured with the same active filter coefficient set 320 and can process a number of rows of the reference pixel window 335 in parallel that corresponds to the number of available horizontal interpolation filters 315 (which is 4 filters in the illustrated example of FIG. 3).

Turning to FIG. 5, the vertical filtering operations 500 begin with the reference pixel window multiplexing circuitry 365 providing the intermediate horizontal filtered pixel data 368 to the vertical interpolation filters 345. In the vertical filtering operations 500, the vertical interpolation filters 345 then filter each column of the intermediate horizontal filtered pixel data 368 to produce the predicted pixel block 370, as described above. The ovals illustrated in each column of the intermediate horizontal filtered pixel data 368 identify the subsets of reference pixels to be filtered with each shift of the vertical interpolation filters 345 down the column. In the illustrated example, each shift has a stride of 2 pixel positions corresponding to the scale factor of 0.5. In the illustrated example, vertical filtering operations 500, the vertical interpolation filters 345 are each configured with the same active filter coefficient set 350 and can process a number of columns of the intermediate horizontal filtered pixel data 368 in parallel that corresponds to the number of available vertical interpolation filters 345 (which is 4 filters in the illustrated example of FIG. 3).

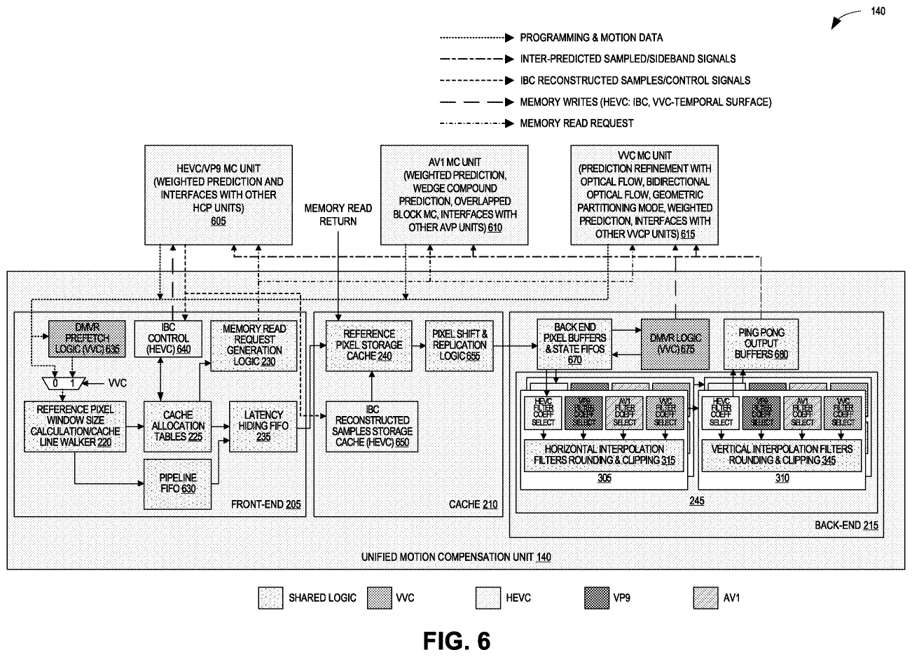

FIG. 6 is a block diagram illustrating a second example implementation of the UMC circuitry 140 of FIG. 1. The UMC circuitry 140 of FIG. 6 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the UMC circuitry 140 of FIG. 6 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 6 may, thus, be instantiated at the same or different times. Some or all of the circuitry of FIG. 6 may be instantiated, for example, in one or more threads executing concurrently on hardware and/or in series on hardware. Moreover, in some examples, some or all of the circuitry of FIG. 6 may be implemented by microprocessor circuitry executing instructions and/or FPGA circuitry performing operations to implement one or more virtual machines and/or containers.

The example UMC circuitry 140 of FIG. 6 includes the example front-end circuitry 205, the example cache circuitry 210, and the example back-end circuitry 215 described above in connection with FIG. 2. The example front-end circuitry 205 of FIG. 6 includes the example window size calculation circuitry 220, the example cache allocation table(s) 225, the example memory read request generation circuitry 230, and the example latency hiding buffer circuitry 235 described above in connection with FIG. 2. The example cache circuitry 210 of FIG. 6 implements the example reference pixel storage cache 240 described above in connection with FIG. 2. The example back-end circuitry 215 of FIG. 6 includes the example interpolation filter circuitry 245 described above in connection with FIG. 2, which further includes the example horizontal filtering circuitry 305 and the example vertical filtering circuitry 310 described above in connection with FIG. 3.

The example UMC circuitry 140 of FIG. 6 also includes dedicated video codec circuitry for the multiple video codec standards supported by the UMC circuitry 140. Such dedicated video codec circuitry implements motion compensation functionality specific to a particular video codec standard or subset of the multiple video codec standards supported by the UMC circuitry 140. In the illustrated example of FIG. 6, the UMC circuitry 140 includes example HEVC/VP9 motion compensation (MC) circuitry 605, example AV1 MC circuitry 610, and example VVC MC circuitry 615.

The HEVC/VP9 MC circuitry 605 of the illustrated example provides motion compensation functionality specific to HEVC and VP9 video codecs. For example, the HEVC/VP9 MC circuitry 605 implements weighted prediction and compound prediction algorithms specific to HEVC and VP9 codecs. In some examples, the HEVC/VP9 MC circuitry 605 implements the Intra Block Copy (IBC) feature, which supports frame encoding and decoding by copying pixel blocks from one location in the current frame to another location in the current frame.

The AV1 MC circuitry 610 of the illustrated example provides motion compensation functionality specific to AVI video codecs. For example, the AV1 MC circuitry 610 implements weighted prediction and wedge compound prediction algorithms specific to AVI codecs. In some examples, the AVI MC circuitry 610 implements the Overlapped Block Motion Compensation (OBMC) feature, which enables smoother block transitions.

The VVC MC circuitry 615 of the illustrated example provides motion compensation functionality specific to VVC video codecs. For example, the VVC MC circuitry 615 implements optical flow prediction and bi-directional optical flow prediction. In some examples, the VVC MC 615 implements the Decoder Side Motion Vector Refinement (DMVR) feature, which enables fine-grained motion vector adjustments.

In addition to the example window size calculation circuitry 220, the example cache allocation table(s) 225, the example memory read request generation circuitry 230, and the example latency hiding buffer circuitry 235 described above in connection with FIG. 2, the example front-end circuitry 205 of FIG. 6 also includes example DMVR prefetch circuitry 635 for use with the VVC MC circuitry 615, example IBC control circuitry 640 for use with the HEVC/VP9 MC circuitry 605, and an example pipeline FIFO 630. The DMVR prefetch circuitry 635 of the illustrated example prefetches reference pixel data for VVC decoder side motion vector refinement operations. In some examples, the DMVR prefetch circuitry 635 prepares reference pixel data for motion vector refinement in VVC decoding. In some examples, the DMVR prefetch circuitry 635 includes a dedicated reference pixel buffer for storing pixel data used in motion vector refinement operations.

The IBC control circuitry 640 of the illustrated example manages Intra Block Copy operations for HEVC codecs. In some examples, the IBC control circuitry 640 controls the selection and processing of intra-block copy operations. In some examples, the IBC control circuitry 640 enables the processing of blocks that are copied within the same frame.

The pipeline FIFO 630 of the illustrated example buffers motion compensation data to manage pipeline flow. In some examples, the pipeline FIFO 630 is a specialized buffer that coordinates the execution of motion compensation operations.

In addition to the example reference pixel storage cache 240 described above in connection with FIG. 2, the example cache circuitry 210 of FIG. 6 also includes an example IBC reconstructed samples storage cache 650 and example pixel shift and replication logic 655. The IBC reconstructed samples storage cache 650 of the illustrated example stores reconstructed samples for Intra Block Copy operations. For example, the IBC reconstructed samples storage cache 650 provides a dedicated storage structure for storing reconstructed samples used for block copy operations.

The pixel shift and replication logic 655 of the illustrated example implements reference pixel shift and replication operations. In some examples, the pixel shift and replication logic 655 includes circuitry that shifts reference pixel data out of the cache 240. For example, the pixel shift and replication logic 655 may shift reference pixel data based on the fractional motion vector position to align with the filter taps of the interpolation filter circuitry 245. In some examples, the pixel shift and replication logic 655 includes circuitry that replicates reference pixel data for situations in which the reference pixel window determined for interpolation filtering extends beyond the frame edge. In some such examples, the pixel shift and replication logic 655 adjusts the pixel coordinates and duplicates edge pixels to maintain continuity. For example, the pixel shift and replication logic 655 replicates reference pixel data for pixels outside the reference frame boundaries.

In addition to the example interpolation filter circuitry 245 described above in connection with FIG. 2, the example back-end circuitry 215 of FIG. 6 includes example back-end pixel buffers and state FIFOS 670, example DMVR circuitry 675 for use with the VVC MC circuitry 615, and example ping-pong output buffers 680. The back-end pixel buffers and state FIFOS 670 store pixel data and state information for subsequent processing stages. For example, the back-end pixel buffers and state FIFOS 670 may include circuitry that buffers up to 16 pixel data entries. In some examples, the back-end pixel buffers and state FIFOS 670 manage state information for the motion compensation operations. For example, the back-end pixel buffers and state FIFOS 670 manage state information used by the interpolation filter circuitry 245.

The DMVR circuitry 675 implements Decoder Side Motion Vector Refinement (DMVR) functionality for the VVC MC circuitry 615. In some examples, the DMVR circuitry 675 refines motion vectors based on previous motion vectors and reference pixel data.

The ping-pong output buffers 680 store motion compensation output data. In some examples, the ping-pong output buffers 680 include circuitry that buffers output data in a ping-pong manner to support efficient pipeline operation.

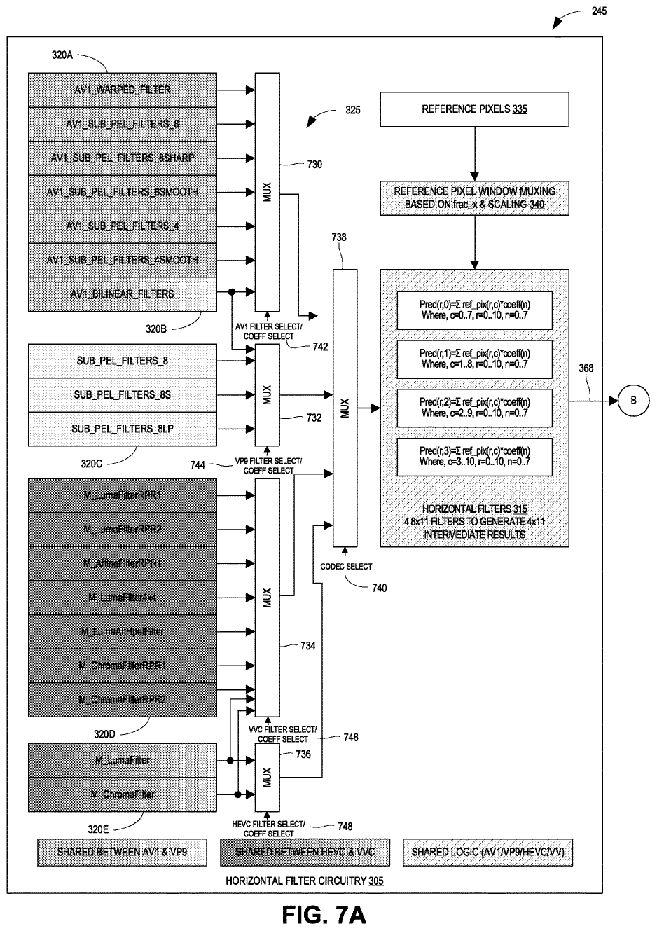

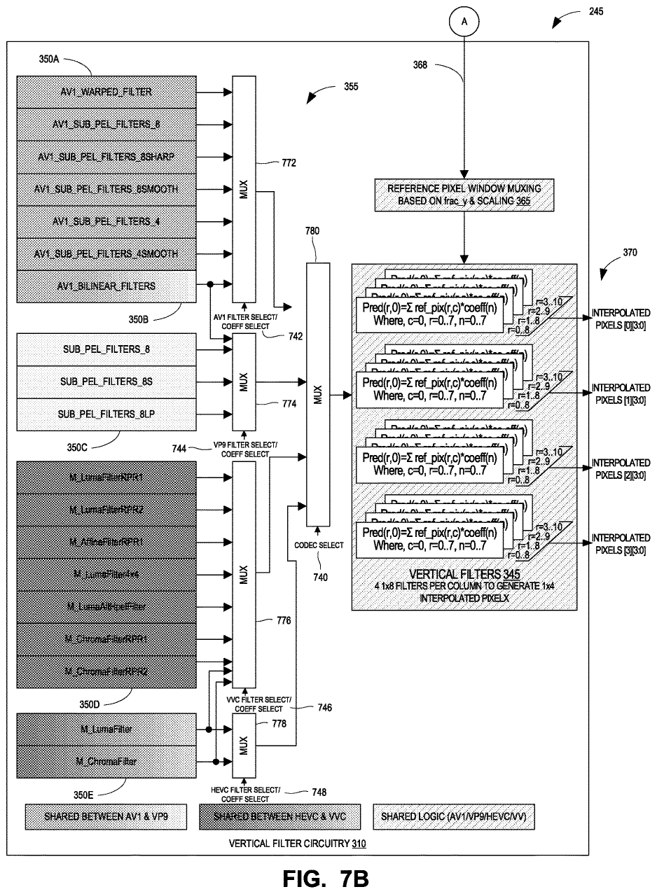

FIG. 7, which includes FIGS. 7A and 7B, is a block diagram of a second example implementation of the interpolation filter circuitry 245 of FIG. 2 that can be used to implement the example UMC circuitry 140 of FIG. 6. The interpolation filter circuitry 245 of FIG. 7 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the interpolation filter circuitry 245 of FIG. 7 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 7 may, thus, be instantiated at the same or different times. Some or all of the circuitry of FIG. 7 may be instantiated, for example, in one or more threads executing concurrently on hardware and/or in series on hardware. Moreover, in some examples, some or all of the circuitry of FIG. 7 may be implemented by microprocessor circuitry executing instructions and/or FPGA circuitry performing operations to implement one or more virtual machines and/or containers.

The example interpolation filter circuitry 245 of FIG. 6 includes the example horizontal filtering circuitry 305 and the example vertical filtering circuitry 310 described above in connection with FIG. 3. The example horizontal filtering circuitry 305 and the example vertical filtering circuitry 310 of FIG. 6 include the example configurable horizontal interpolation filters 315 and the example configurable vertical interpolation filters 345, respectively, as described above in connection with FIG. 3. The example horizontal filtering circuitry 305 and the example vertical filtering circuitry 310 of FIG. 6 also include the example horizontal filter coefficient groups 320A-E and the example vertical filter coefficient group 350A-E, respectively, as described above in connection with FIG. 3. The example horizontal filtering circuitry 305 and the example vertical filtering circuitry 310 of FIG. 6 also include the example filter selection multiplexer circuitry 325 and the example filter selection multiplexer circuitry 355, respectively, as described above in connection with FIG. 3. The example horizontal filtering circuitry 305 and the example vertical filtering circuitry 310 of FIG. 6 further include the example reference pixel window multiplexing circuitry 340 and the example reference pixel window multiplexing circuitry 365, respectively, described above in connection with FIG. 3.

In the illustrated example of FIG. 6, the horizontal filter coefficient group 320A includes an example warped filter coefficient set and various example sub-pixel filter coefficient sets dedicated to the AV1 coding standard. In the illustrated example, the horizontal filter coefficient group 320B includes an example bilinear filter coefficient set shared between the AV1 and VP9 coding standards. In the illustrated example, the horizontal filter coefficient group 320C includes various example sub-pixel filter coefficient sets dedicated to the VP9 coding standard. In the illustrated example, the horizontal filter coefficient group 320D includes various example luma filter coefficient sets and various example chroma filter coefficient sets dedicated to the VVC coding standard. In the illustrated example, the horizontal filter coefficient group 320E includes an example luma filter coefficient set and an example chroma filter coefficient set shared between the VVC and HEVC coding standards.

In the illustrated example of FIG. 6, the vertical filter coefficient group 350A includes an example warped filter coefficient set and various example sub-pixel filter coefficient sets dedicated to the AV1 coding standard. In the illustrated example, the vertical filter coefficient group 350B includes an example bilinear filter coefficient set shared between the AV1 and VP9 coding standards. In the illustrated example, the vertical filter coefficient group 350C includes various example sub-pixel filter coefficient sets dedicated to the VP9 coding standard. In the illustrated example, the vertical filter coefficient group 350D includes various example luma filter coefficient sets and various example chroma filter coefficient sets dedicated to the VVC coding standard. In the illustrated example, the vertical filter coefficient group 350E includes an example luma filter coefficient set and an example chroma filter coefficient set shared between the VVC and HEVC coding standards.

In the illustrated example of FIG. 6, the example filter selection multiplexer circuitry 325 is implemented using a hierarchical multiplexer structure. The hierarchical multiplexer structure of the illustrated example includes example coefficient set selection multiplexers 730, 732, 734 and 736 to implement a first level of the multiplexer hierarchy that selects a particular horizontal filter coefficient set for a particular video codec standard based on example coefficient selection signals 742, 744, 746 and 748. The hierarchical multiplexer structure of the illustrated example also includes an example codec selection multiplexer 738 to route the particular selected horizontal filter coefficient set for the active video codec identified by an example codec selection 740 to the horizontal interpolation filters 315.

Similarly, in the illustrated example of FIG. 6, the example filter selection multiplexer circuitry 355 is implemented using a hierarchical multiplexer structure. The hierarchical multiplexer structure of the illustrated example includes example coefficient set selection multiplexers 772, 774, 776 and 778 to implement a first level of the multiplexer hierarchy that selects a particular vertical filter coefficient set for a particular video codec standard based on the example coefficient selection signals 742, 744, 746 and 748. The hierarchical multiplexer structure of the illustrated example also includes an example codec selection multiplexer 780 to route the particular selected vertical filter coefficient set for the active video codec identified by an example codec selection 740 to the vertical interpolation filters 345.

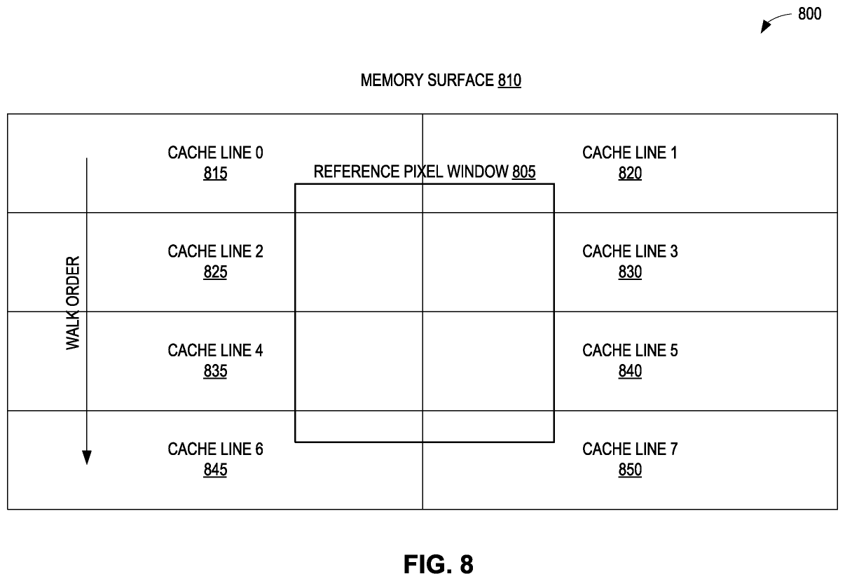

FIG. 8 illustrates an example reference pixel window 805 stored in the example reference pixel storage cache 240 described above. The example of FIG. 8 depicts a portion of an example memory surface 810 that stores example reference pixels associated with a previously decoded frame, also referred to herein as a reference frame. The example FIG. 8 also depicts eight (8) example cache lines 815-840 of the reference pixel storage cache 240. The example FIG. 8 further depicts the example reference pixel window 805 retrieved by the memory read request generation circuitry 230 and stored in the cache lines 815-840 of the cache 240. Based on how the cache lines 815-840 are allocated to the address space of the memory surface 810, the reference pixel window 805 may span multiple cache lines 815-840 in both the horizontal and vertical directions, as shown in FIG. 8.

As an illustrative example, the UMC circuitry 140 operates on generated predicted pixel blocks, also referred to as prediction blocks, as described above. Different video coding standards may support different prediction block sizes and shapes. To support the different prediction block sizes and shapes, the UMC circuitry 140 decomposes each prediction block into one or more 4× 4 pixel prediction blocks. Each 4×4 pixel prediction block within a prediction unit shares the same motion information, including the motion vectors, the interpolation filter type, the prediction direction (unidirectional or bidirectional), and the reference frame that the unit is addressing. In the illustrated example of FIG. 6, the standard specific motion compensation circuitry, such as the HEVC/VP9 MC circuitry 605, the AV1 MC circuitry 610, and the VVC MC circuitry 615, is also structured to process data at a 4×4 pixel granularity, thereby allowing the UMC 140 to consolidate the logic that is common to the different video codecs at each stage of the motion compensation process.

For example, for each 4×4 prediction block, the window size calculation circuitry 220 determines the location and size of the reference pixel window 805 to be fetched from memory and provided to the interpolation filter circuitry 245. This calculation is similar for each of the different video codecs supported by the UMC 140. Also, the VP9, AV1, and VVC codecs support dynamic reference frame scaling, which allows the dimensions of the reference frame to differ from those of the output frame being generated (e.g., encoded or decoded) by the video codec circuitry 126. As such, the window size calculation circuitry 220 utilizes a scaling factor, which may be supplied by the driver 165 and/or the codec-specific MC circuitry 605-615, to adjust the reference block position and motion vectors accordingly. The HEVC codec does not provide dynamic scaling, but the same window size and location calculations can be utilized by having the driver 165 and/or the HEVC/VP9 MC circuitry 605 program the scaling factor to unity, thereby keeping the algorithms implemented by the window size calculation circuitry 220 generic across all codecs.

In some examples, after the reference pixel window 805 has been positioned and its dimensions established, the window size calculation circuitry 220 identifies the cache lines 815-840 in the memory surface 810 that contain the pixels in the reference pixel window 805. Because the reference pixel window 805 may span multiple cache lines 815-840 in both the horizontal and vertical directions, the window size calculation circuitry 220 implements an example walker routine to enumerate the particular cache lines 815-840 to be fetched to ensure the reference pixel window 805 is stored in the cache 240. Because the different video codecs supported by the UMC circuitry 140 employ standard chroma subsampling formats and share a common memory surface layout, the window size calculation circuitry 220 is able to employ the same walker logic among the codecs, thereby reducing gate count. The window size calculation circuitry 220 then provides the enumeration information to the memory read request generation circuitry 230, which generates the sequence of memory read requests to fetch the enumerated cache lines 215-240 into the cache 240.

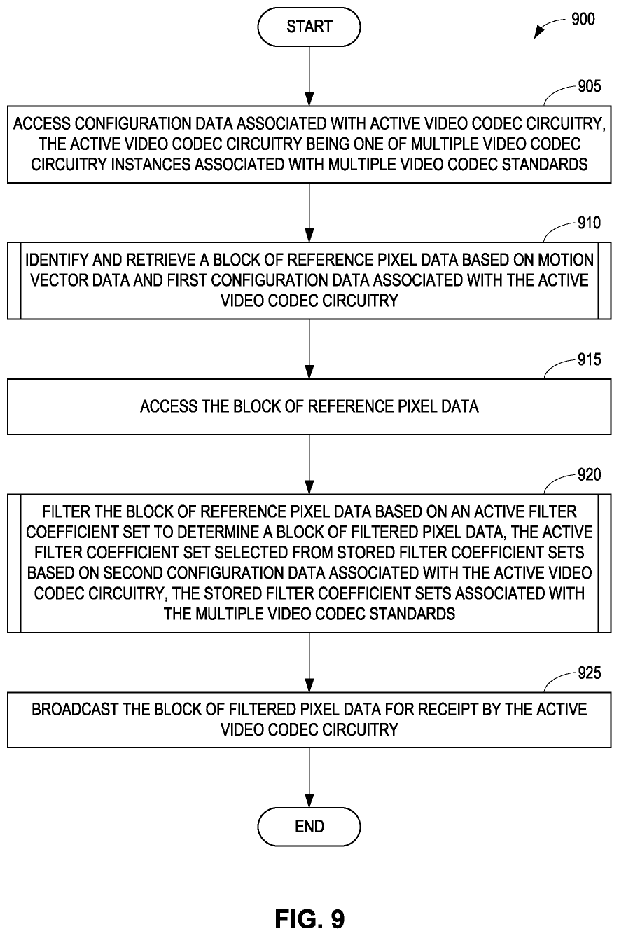

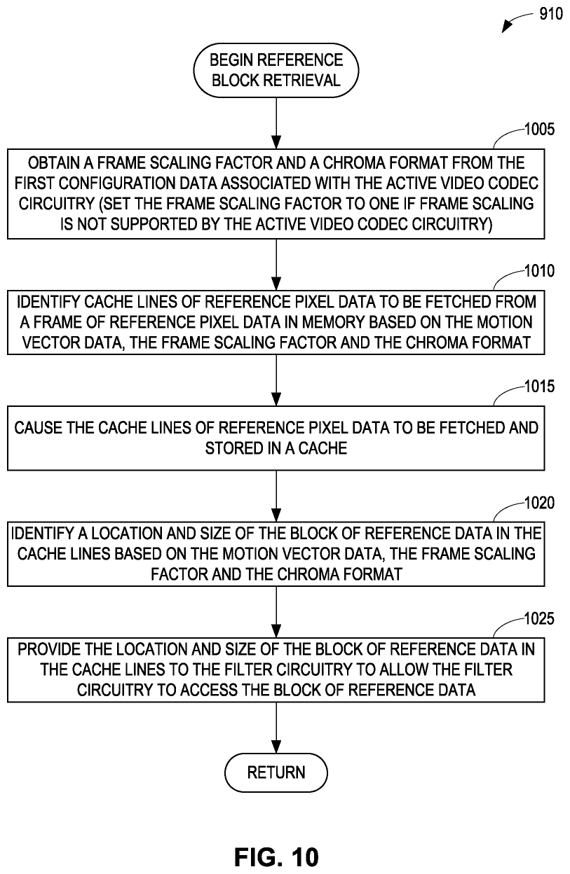

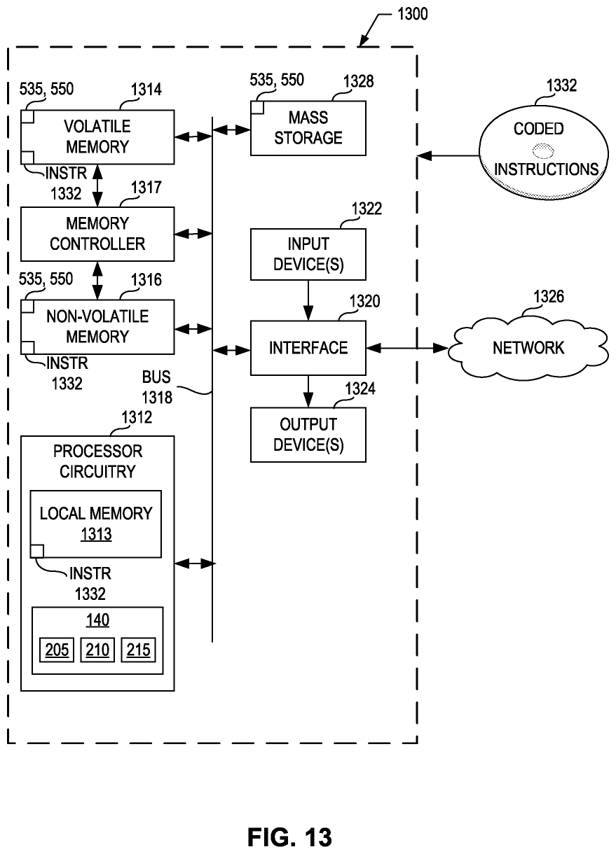

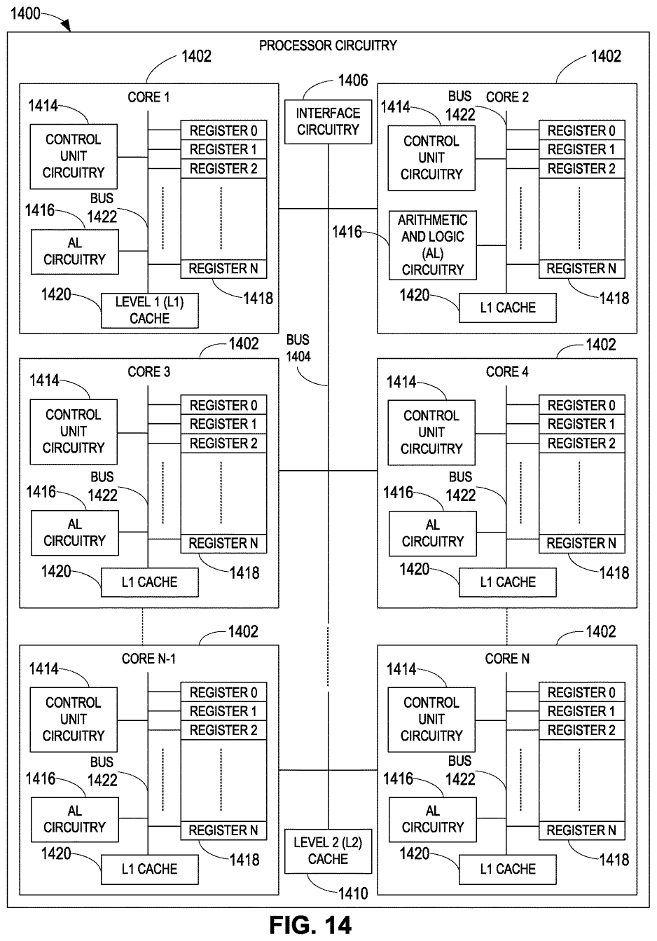

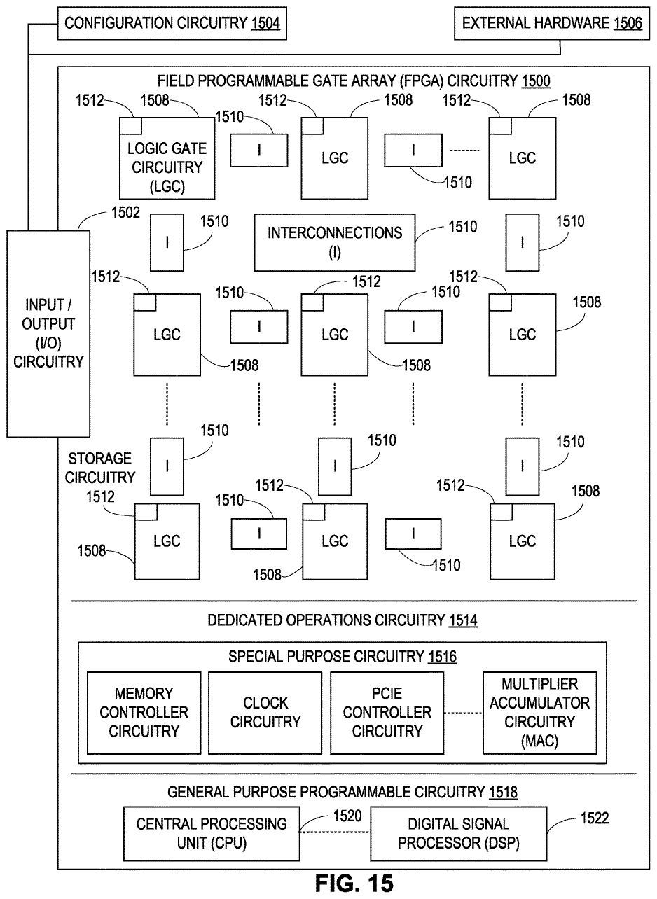

In some examples, the UMC circuitry 140 includes means for retrieving a reference pixel window. For example, the means for retrieving a reference pixel window may be implemented by the front-end circuitry 205. In some examples, the front-end circuitry 205 may be instantiated by programmable circuitry such as the example programmable circuitry 1312 of FIG. 13. For instance, the front-end circuitry 205 may be instantiated by the example microprocessor 1400 of FIG. 14 executing machine executable instructions such as those implemented by at least blocks 905-915 of FIG. 9 and/or blocks 1005-1025 of FIG. 10. In some examples, the front-end circuitry 205 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the front-end circuitry 205 may be instantiated by any other combination of hardware, software, and/or firmware. For example, the front-end circuitry 205 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

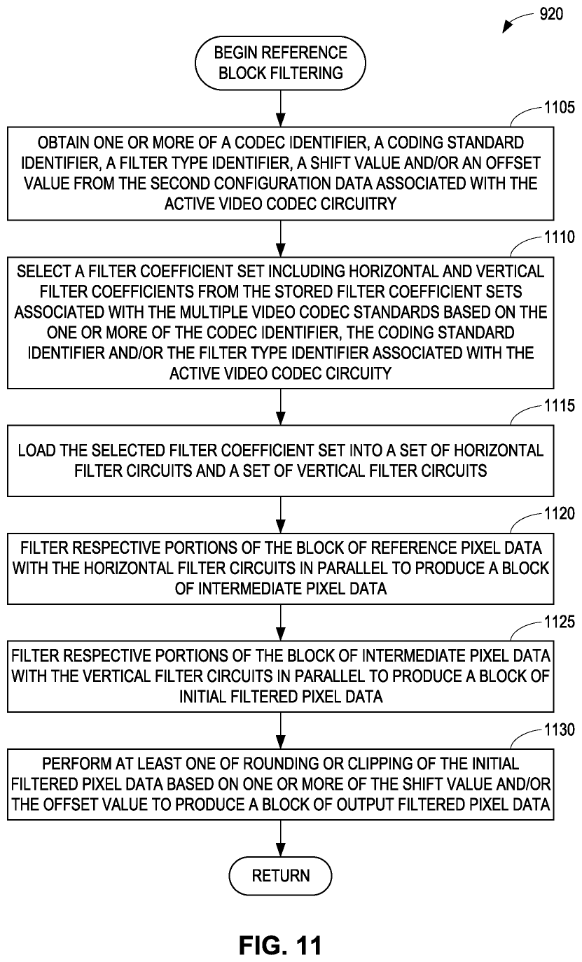

In some examples, the UMC circuitry 140 includes means for filtering a reference pixel window. For example, the means for filtering a reference pixel window may be implemented by the back-end circuitry 215. In some examples, the back-end circuitry 215 may be instantiated by programmable circuitry such as the example programmable circuitry 1312 of FIG. 13. For instance, the back-end circuitry 215 may be instantiated by the example microprocessor 1400 of FIG. 14 executing machine executable instructions such as those implemented by at least blocks 905, 920 and/or 925 of FIG. 9 and/or blocks 1105-1130 of FIG. 11. In some examples, the back-end circuitry 215 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the back-end circuitry 215 may be instantiated by any other combination of hardware, software, and/or firmware. For example, the back-end circuitry 215 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

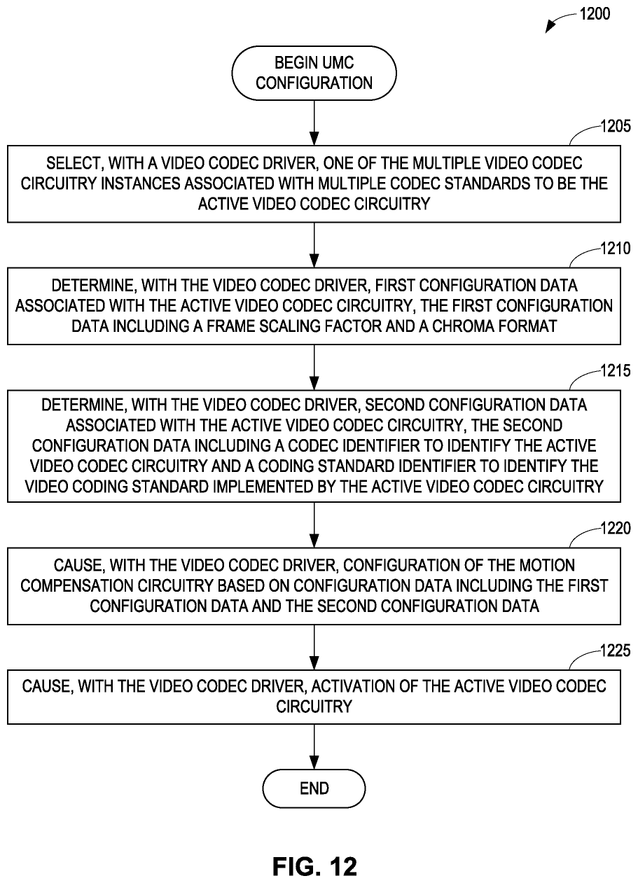

In some examples, the UMC circuitry 140 includes or is associated means for configuring the UMC circuitry 140. For example, the means for configuring may be implemented by the driver 165. In some examples, the driver 165 may be instantiated by programmable circuitry such as the example programmable circuitry 1312 of FIG. 13. For instance, the driver 165 may be instantiated by the example microprocessor 1400 of FIG. 14 executing machine executable instructions such as those implemented by at least blocks 1205-1225 of FIG. 12. In some examples, the back-end circuitry 215 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the back-end circuitry 215 may be instantiated by any other combination of hardware, software, and/or firmware. For example, the back-end circuitry 215 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the example compute device 105 includes means for performing motion compensation. For example, the means for performing motion compensation may be implemented by the UMC circuitry 140. In some examples, the UMC circuitry 140 may be instantiated by programmable circuitry such as the example programmable circuitry 1312 of FIG. 13. For instance, the UMC circuitry 140 may be instantiated by the example microprocessor 1400 of FIG. 14 executing machine executable instructions such as those implemented by at least blocks 905-925 of FIG. 9, blocks 1005-1025 of FIG. 10, and/or blocks 1105-1130 of FIG. 11. In some examples, the UMC circuitry 140 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the UMC circuitry 140 may be instantiated by any other combination of hardware, software, and/or firmware. For example, the UMC circuitry 140 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the example compute device 105 includes video coding means. For example, the video coding means may be implemented by one or more of the HEVC/VP9 MC circuitry 605, the AV1 MC circuitry 610, and/or the VVC MC circuitry 615. In some examples, one or more of the HEVC/VP9 MC circuitry 605, the AV1 MC circuitry 610, and/or the VVC MC circuitry 615 may be instantiated by programmable circuitry such as the example programmable circuitry 1312 of FIG. 13. For instance, one or more of the HEVC/VP9 MC circuitry 605, the AV1 MC circuitry 610, and/or the VVC MC circuitry 615 may be instantiated by the example microprocessor 1400 of FIG. 14 executing corresponding video coding machine executable instructions. In some examples, one or more of the HEVC/VP9 MC circuitry 605, the AV1 MC circuitry 610, and/or the VVC MC circuitry 615 may be instantiated by hardware logic circuitry, which may be implemented by an ASIC, XPU, or the FPGA circuitry 1500 of FIG. 15 configured and/or structured to perform operations corresponding to the video coding machine-readable instructions. Additionally or alternatively, one or more of the HEVC/VP9 MC circuitry 605, the AV1 MC circuitry 610, and/or the VVC MC circuitry 615 may be instantiated by any other combination of hardware, software, and/or firmware. For example, one or more of the HEVC/VP9 MC circuitry 605, the AV1 MC circuitry 610, and/or the VVC MC circuitry 615 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the UMC circuitry 140 of FIG. 1 is illustrated in FIGS. 2 and/or 6, one or more of the elements, processes, and/or devices illustrated in FIGS. 2 and/or 6 may be combined, divided, re-arranged, omitted, eliminated, and/or implemented in any other way. Further, the example front-end circuitry 205, the example cache circuitry 210, the example back-end circuitry 215, the example window size calculation circuitry 220, the example cache allocation table(s) 225, the example memory read request generation circuitry 230, the example latency hiding buffer circuitry 235, the example interpolation filter circuitry 245, the example horizontal filter circuitry 305, the example vertical filtering circuitry 310, the example horizontal interpolation filters 315, the example vertical interpolation filters 345, the example filter selection multiplexer circuitry 325 and/or 355, the example reference pixel window multiplexing circuitry 340 and/or 365, the example HEVC/VP9 MC circuitry 605, the example AV1 MC circuitry 610, the example VVC MC circuitry 615, the example pipeline FIFO 630, the example DMVR prefetch circuitry 635, the example IBC control circuitry 640, the example IBC reconstructed samples storage cache 650, the example reference pixel shift and replication logic 655, the example back-end pixel buffers and state FIFOS 670, the example DMVR circuitry 675, the example ping-pong output buffers 680, and/or, more generally, the example UMC circuitry 140 of FIGS. 2 and/or 6, may be implemented by hardware alone or by hardware in combination with software and/or firmware. Thus, for example, any of the example front-end circuitry 205, the example cache circuitry 210, the example back-end circuitry 215, the example window size calculation circuitry 220, the example cache allocation table(s) 225, the example memory read request generation circuitry 230, the example latency hiding buffer circuitry 235, the example interpolation filter circuitry 245, the example horizontal filter circuitry 305, the example vertical filtering circuitry 310, the example horizontal interpolation filters 315, the example vertical interpolation filters 345, the example filter selection multiplexer circuitry 325 and/or 355, the example reference pixel window multiplexing circuitry 340 and/or 365, the example HEVC/VP9 MC circuitry 605, the example AV1 MC circuitry 610, the example VVC MC circuitry 615, the example pipeline FIFO 630, the example DMVR prefetch circuitry 635, the example IBC control circuitry 640, the example IBC reconstructed samples storage cache 650, the example reference pixel shift and replication logic 655, the example back-end pixel buffers and state FIFOS 670, the example DMVR circuitry 675, the example ping-pong output buffers 680, and/or, more generally, the example UMC circuitry 140, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example UMC circuitry 140 of FIGS. 2 and/or 6 may include one or more elements, processes, and/or devices in addition to, or instead of, those illustrated in FIGS. 2 and/or 6, and/or may include more than one of any or all of the illustrated elements, processes and devices.

Flowchart(s) representative of example machine-readable instructions, which may be executed by programmable circuitry to implement and/or instantiate the UMC circuitry 140 of FIGS. 2 and/or 6 and/or representative of example operations which may be performed by programmable circuitry to implement and/or instantiate the UMC circuitry 140 of FIGS. 2 and/or 6, are shown in FIGS. 9-12. The machine-readable instructions may be one or more executable programs or portion(s) of one or more executable programs for execution by programmable circuitry such as the programmable circuitry 1312 shown in the example processor platform 1300 discussed below in connection with FIG. 13 and/or may be one or more function(s) or portion(s) of functions to be performed by the example programmable circuitry (e.g., an FPGA) discussed below in connection with FIGS. 14 and/or 15. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 9-12, many other methods of implementing the example UMC circuitry 140 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above. As used herein, the term “circuitry” refers to at least one “circuit.” Thus, circuitry refers to a circuit or a system of circuits. As used herein, programmable circuitry includes and/or corresponds to at least one programmable circuit.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 9-12 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 9 is a flowchart representative of example machine-readable instructions and/or example operations 900 that may be executed, instantiated, and/or performed by programmable circuitry to implement the UMC circuitry 140. The example machine-readable instructions and/or the example operations 900 of FIG. 9 begin at block 905, at which the front-end circuitry 205 and the back-end circuitry 215 of the UMC circuitry 140 access, as described above, configuration data associated with the active video codec circuitry. As described above, the active video codec circuitry can be one of multiple video codec circuitry instances associated with multiple video codec standards, such as the HEVC/VP9 MC circuitry 605, the AV1 MC circuitry 610, and/or the VVC MC circuitry 615 of the UMC circuitry 140. In some examples, the front-end circuitry 205 and/or the back-end circuitry 215 access the configuration data from the active video codec circuitry. In some examples, the front-end circuitry 205 and/or the back-end circuitry 215 additionally or alternatively access the configuration data from the driver 165.

At block 910, the window size calculation circuitry 220 of the front-end circuitry 205 identifies a block of reference pixel data based on motion vector data and first configuration data associated with the active video codec circuitry, as described above. At block 910, the window size calculation circuitry 220 of the front-end circuitry 205 also causes the memory read request generation circuitry 230 of the front-end circuitry 205 to generate a memory read request to cause the identified block of reference pixel data to be retrieved and stored in the cache 240 implemented by the cache circuitry 210, as described above.

At block 915, the interpolation filter circuitry 245 of the UMC 140 accesses the block of reference pixel data. At block 920, the interpolation filter circuitry 245 filters, as described above, the block of reference pixel data based on an active filter coefficient set to determine a block of filtered pixel data. As described above, the interpolation filter circuitry 245 selects the active filter coefficient set from stored filter coefficient sets 320A-E and 350A-E based on second configuration data associated with the active video codec circuitry. As also described above, the stored filter coefficient sets 320A-E and 350A-E are associated with the multiple video codec standards supported by the UMC 140. At block 925, the interpolation filter circuitry 245 broadcasts the block of filtered pixel data for receipt by the active video codec circuitry, as described above. Execution of the machine-readable instructions and/or example operations 900 then ends.

FIG. 10 is a flowchart representative of example machine-readable instructions and/or example operations 910 that may be executed, instantiated, and/or performed by programmable circuitry to implement reference pixel data retrieval in the UMC circuitry 140 and/or the processing at block 910 of FIG. 9. The example machine-readable instructions and/or the example operations 910 of FIG. 10 begin at block 1005, at which the window size calculation circuitry 220 of the front-end circuitry 205 of the UMC circuitry 140 obtains a frame scaling factor and a chroma format from the first configuration data associated with the active video codec circuitry (e.g., obtained at block 905 of FIG. 9), as described above. In some examples, the frame scaling factor is set to one in the accessed configuration data if frame scaling is not supported by the active video codec circuitry. In some examples, the window size calculation circuitry 220 sets the frame scaling factor to one if the frame scaling factor is not present in the accessed configuration data.

At block 1010, the window size calculation circuitry 220 identifies cache lines of reference pixel data to be fetched from a frame of reference pixel data in memory based on the motion vector data, the frame scaling factor and the chroma format, as described above. At block 1015, the window size calculation circuitry 220 causes the memory read request generation circuitry 230 of the front-end circuitry 205 to generate one or more memory read requests to cause the cache lines of reference pixel data to be fetched and stored in the cache 240 implemented by the cache circuitry 210, as described above. At block 1020, the window size calculation circuitry 220 identifies a location and size of the block of reference data in the cache lines based on the motion vector data, the frame scaling factor and the chroma format, as described above. At block 1025, the window size calculation circuitry 220 provides the location and size of the block of reference data in the cache lines to the interpolation filter circuitry 245 of the UMC 140 to allow the interpolation filter circuitry 245 to access the block of reference data. The example machine-readable instructions and/or example operations 910 then end.

FIG. 11 is a flowchart representative of example machine-readable instructions and/or example operations 920 that may be executed, instantiated, and/or performed by programmable circuitry to implement reference block filtering in the UMC circuitry 140 and/or the processing at block 920 of FIG. 9. The example machine-readable instructions and/or the example operations 920 of FIG. 11 begin at block 1105, at which the interpolation filter circuitry 245 of the UMC 140 obtains one or more of a codec identifier, a coding standard identifier, a filter type identifier, a shift value and/or an offset value from the second configuration data associated with the active video codec circuitry (e.g., obtained at block 905 of FIG. 9), as described above. At block 1110, the interpolation filter circuitry 245 selects an active filter coefficient set including horizontal and vertical filter coefficients from the stored filter coefficient sets 320A-E and 350A-E associated with the multiple video codec standards based on the one or more of the codec identifier, the coding standard identifier and/or the filter type identifier associated with the active video codec circuitry, as described above. At block 1115, the interpolation filter circuitry 245 loads the selected filter coefficient set into the set of horizontal filter circuits 315 and the set of vertical filter circuits 345, as described above.

At block 1120, the interpolation filter circuitry 245 filters respective portions of the block of reference pixel data with the horizontal filter circuits 315 in parallel to produce a block of intermediate pixel data 368, as described above. At block 1125, the interpolation filter circuitry 245 filters respective portions of the block of intermediate pixel data 168 with the vertical filter circuits 345 in parallel to produce a block of initial filtered pixel data, as described above. At block 1130, the vertical filter circuits 345 perform at least one of rounding or clipping of the initial filtered pixel data based on one or more of the shift value and/or the offset value to produce a block of output filtered pixel data 370, as described above. The example machine-readable instructions and/or example operations 920 then end.

FIG. 12 is a flowchart representative of example machine-readable instructions and/or example operations 1200 that may be executed, instantiated, and/or performed by programmable circuitry to configure the UMC circuitry 140 with the driver 165. The example machine-readable instructions and/or the example operations 1200 of FIG. 12 begin at block 1205, at which the driver 165 selects, one of the multiple video codec circuitry instances 605-615 associated with multiple video codec standards to be the active video codec circuitry, as described above. At block 1210, the driver 165 determines first configuration data associated with the active video codec circuitry, as described above. For example, the first configuration data includes a frame scaling factor and a chroma format. At block 1215, the driver 165 determines second configuration data associated with the active video codec circuitry, as described above. For example, the second configuration data includes a codec identifier to identify the active video codec circuitry and a coding standard identifier to identify the video coding standard implemented by the active video codec circuitry. At block 1220, the driver 165 causes configuration of the UMC circuitry 140 based on configuration data including the first configuration data and the second configuration data, as described above. At block 1225, the driver 165 causes activation of the active video codec circuitry, as described above. The machine-readable instructions and/or example operations 1200 then end.

FIG. 13 is a block diagram of an example programmable circuitry platform 1300 structured to execute and/or instantiate the example machine-readable instructions and/or the example operations of FIGS. 9-12 to implement the UMC circuitry 140 of FIGS. 2 and/or 6. The programmable circuitry platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1300 of the illustrated example includes programmable circuitry 1312. The programmable circuitry 1312 of the illustrated example is hardware. For example, the programmable circuitry 1312 can be implemented by one or more integrated circuits, logic circuits, FPGAs, microprocessors, CPUs, GPUs, VPUs, DSPs, and/or microcontrollers from any desired family or manufacturer. The programmable circuitry 1312 may be implemented by one or more semiconductor based (e.g., silicon based) devices. In this example, the programmable circuitry 1312 implements the example front-end circuitry 205, the example cache circuitry 210 and/or the example back-end circuitry 215 of the UMC circuitry 140.

The programmable circuitry 1312 of the illustrated example includes a local memory 1313 (e.g., a cache, registers, etc.). The programmable circuitry 1312 of the illustrated example is in communication with main memory 1314, 1316, which includes a volatile memory 1314 and a non-volatile memory 1316, by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317. In some examples, the memory controller 1317 may be implemented by one or more integrated circuits, logic circuits, microcontrollers from any desired family or manufacturer, or any other type of circuitry to manage the flow of data going to and from the main memory 1314, 1316.

The programmable circuitry platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1322 are connected to the interface circuitry 1320. The input device(s) 1322 permit(s) a user (e.g., a human user, a machine user, etc.) to enter data and/or commands into the programmable circuitry 1312. The input device(s) 1322 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1324 are also connected to the interface circuitry 1320 of the illustrated example. The output device(s) 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1300 of the illustrated example also includes one or more mass storage discs or devices 1328 to store firmware, software, and/or data. Examples of such mass storage discs or devices 1328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1332, which may be implemented by the machine-readable instructions of FIGS. 9-12, may be stored in the mass storage device 1328, in the volatile memory 1314, in the non-volatile memory 1316, and/or on at least one non-transitory computer-readable storage medium such as a CD or DVD which may be removable.

FIG. 14 is a block diagram of an example implementation of the programmable circuitry 1312 of FIG. 13. In this example, the programmable circuitry 1312 of FIG. 13 is implemented by a microprocessor 1400. For example, the microprocessor 1400 may be a general-purpose microprocessor (e.g., general-purpose microprocessor circuitry). The microprocessor 1400 executes some or all of the machine-readable instructions of the flowcharts of FIGS. 9-12 to effectively instantiate the circuitry of FIGS. 2 and/or 6 as logic circuits to perform operations corresponding to those machine-readable instructions. In some such examples, the circuitry of FIGS. 2 and/or 6 is instantiated by the hardware circuits of the microprocessor 1400 in combination with the machine-readable instructions. For example, the microprocessor 1400 may be implemented by multi-core hardware circuitry such as a CPU, a DSP, a GPU, an XPU, etc. Although it may include any number of example cores 1402 (e.g., 1 core), the microprocessor 1400 of this example is a multi-core semiconductor device including N cores. The cores 1402 of the microprocessor 1400 may operate independently or may cooperate to execute machine-readable instructions. For example, machine code corresponding to a firmware program, an embedded software program, or a software program may be executed by one of the cores 1402 or may be executed by multiple ones of the cores 1402 at the same or different times. In some examples, the machine code corresponding to the firmware program, the embedded software program, or the software program is split into threads and executed in parallel by two or more of the cores 1402. The software program may correspond to a portion or all of the machine-readable instructions and/or operations represented by the flowcharts of FIGS. 9-12.

The cores 1402 may communicate by a first example bus 1404. In some examples, the first bus 1404 may be implemented by a communication bus to effectuate communication associated with one(s) of the cores 1402. For example, the first bus 1404 may be implemented by at least one of an Inter-Integrated Circuit (I2C) bus, a Serial Peripheral Interface (SPI) bus, a PCI bus, or a PCIe bus. Additionally or alternatively, the first bus 1404 may be implemented by any other type of computing or electrical bus. The cores 1402 may obtain data, instructions, and/or signals from one or more external devices by example interface circuitry 1406. The cores 1402 may output data, instructions, and/or signals to the one or more external devices by the interface circuitry 1406. Although the cores 1402 of this example include example local memory 1420 (e.g., Level 1 (L1) cache that may be split into an L1 data cache and an L1 instruction cache), the microprocessor 1400 also includes example shared memory 1410 that may be shared by the cores (e.g., Level 2 (L2 cache)) for high-speed access to data and/or instructions. Data and/or instructions may be transferred (e.g., shared) by writing to and/or reading from the shared memory 1410. The local memory 1420 of each of the cores 1402 and the shared memory 1410 may be part of a hierarchy of storage devices including multiple levels of cache memory and the main memory (e.g., the main memory 1314, 1316 of FIG. 13). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1402 may be referred to as a CPU, DSP, GPU, etc., or any other type of hardware circuitry. Each core 1402 includes control unit circuitry 1414, arithmetic and logic (AL) circuitry (sometimes referred to as an ALU) 1416, a plurality of registers 1418, the local memory 1420, and a second example bus 1422. Other structures may be present. For example, each core 1402 may include vector unit circuitry, single instruction multiple data (SIMD) unit circuitry, load/store unit (LSU) circuitry, branch/jump unit circuitry, floating-point unit (FPU) circuitry, etc. The control unit circuitry 1414 includes semiconductor-based circuits structured to control (e.g., coordinate) data movement within the corresponding core 1402. The AL circuitry 1416 includes semiconductor-based circuits structured to perform one or more mathematic and/or logic operations on the data within the corresponding core 1402. The AL circuitry 1416 of some examples performs integer based operations. In other examples, the AL circuitry 1416 also performs floating-point operations. In yet other examples, the AL circuitry 1416 may include first AL circuitry that performs integer-based operations and second AL circuitry that performs floating-point operations. In some examples, the AL circuitry 1416 may be referred to as an Arithmetic Logic Unit (ALU).

The registers 1418 are semiconductor-based structures to store data and/or instructions such as results of one or more of the operations performed by the AL circuitry 1416 of the corresponding core 1402. For example, the registers 1418 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1418 may be arranged in a bank as shown in FIG. 14. Alternatively, the registers 1418 may be organized in any other arrangement, format, or structure, such as by being distributed throughout the core 1402 to shorten access time. The second bus 1422 may be implemented by at least one of an I2C bus, a SPI bus, a PCI bus, or a PCIe bus.

Each core 1402 and/or, more generally, the microprocessor 1400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1400 is a semiconductor device fabricated to include many transistors interconnected to implement the structures described above in one or more integrated circuits (ICs) contained in one or more packages.

The microprocessor 1400 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1400, in the same chip package as the microprocessor 1400 and/or in one or more separate packages from the microprocessor 1400.

FIG. 15 is a block diagram of another example implementation of the programmable circuitry 1312 of FIG. 13. In this example, the programmable circuitry 1312 is implemented by FPGA circuitry 1500. For example, the FPGA circuitry 1500 may be implemented by an FPGA. The FPGA circuitry 1500 can be used, for example, to perform operations that could otherwise be performed by the example microprocessor 1400 of FIG. 14 executing corresponding machine-readable instructions. However, once configured, the FPGA circuitry 1500 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1400 of FIG. 14 described above (which is a general purpose device that may be programmed to execute some or all of the machine-readable instructions represented by the flowchart(s) of FIGS. 9-12 but whose interconnections and logic circuitry are fixed once fabricated), the FPGA circuitry 1500 of the example of FIG. 15 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 9-12. In particular, the FPGA circuitry 1500 may be thought of as an array of logic gates, interconnections, and switches. The switches can be programmed to change how the logic gates are interconnected by the interconnections, effectively forming one or more dedicated logic circuits (unless and until the FPGA circuitry 1500 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 9-12. As such, the FPGA circuitry 1500 may be configured and/or structured to effectively instantiate some or all of the operations/functions corresponding to the machine-readable instructions of the flowchart(s) of FIGS. 9-12 as dedicated logic circuits to perform the operations/functions corresponding to those software instructions in a dedicated manner analogous to an ASIC. Therefore, the FPGA circuitry 1500 may perform the operations/functions corresponding to the some or all of the machine-readable instructions of FIGS. 9-12 faster than the general-purpose microprocessor can execute the same.

In the example of FIG. 15, the FPGA circuitry 1500 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

The FPGA circuitry 1500 of FIG. 15, includes example input/output (I/O) circuitry 1502 to obtain and/or output data to/from example configuration circuitry 1504 and/or external hardware 1506. For example, the configuration circuitry 1504 may be implemented by interface circuitry that may obtain a binary file, which may be implemented by a bit stream, data, and/or machine-readable instructions, to configure the FPGA circuitry 1500, or portion(s) thereof. In some such examples, the configuration circuitry 1504 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1506 may be implemented by external hardware circuitry. For example, the external hardware 1506 may be implemented by the microprocessor 1400 of FIG. 14.

The FPGA circuitry 1500 also includes an array of example logic gate circuitry 1508, a plurality of example configurable interconnections 1510, and example storage circuitry 1512. The logic gate circuitry 1508 and the configurable interconnections 1510 are configurable to instantiate one or more operations/functions that may correspond to at least some of the machine-readable instructions of FIGS. 9-12 and/or other desired operations. The logic gate circuitry 1508 shown in FIG. 15 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1508 to enable configuration of the electrical structures and/or the logic gates to form circuits to perform desired operations/functions. The logic gate circuitry 1508 may include other electrical structures such as look-up tables (LUTs), registers (e.g., flip-flops or latches), multiplexers, etc.

The configurable interconnections 1510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1508 to program desired logic circuits.

The storage circuitry 1512 of the illustrated example is structured to store result(s) of the one or more of the operations performed by corresponding logic gates. The storage circuitry 1512 may be implemented by registers or the like. In the illustrated example, the storage circuitry 1512 is distributed amongst the logic gate circuitry 1508 to facilitate access and increase execution speed.

The example FPGA circuitry 1500 of FIG. 15 also includes example dedicated operations circuitry 1514. In this example, the dedicated operations circuitry 1514 includes special purpose circuitry 1516 that may be invoked to implement commonly used functions to avoid the need to program those functions in the field. Examples of such special purpose circuitry 1516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1500 may also include example general purpose programmable circuitry 1518 such as an example CPU 1520 and/or an example DSP 1522. Other general purpose programmable circuitry 1518 may additionally or alternatively be present such as a GPU, an XPU, etc., that can be programmed to perform other operations.

Although FIGS. 14 and 15 illustrate two example implementations of the programmable circuitry 1312 of FIG. 13, many other approaches are contemplated. For example, FPGA circuitry may include an on-board CPU, such as one or more of the example CPU 1520 of FIG. 14. Therefore, the programmable circuitry 1312 of FIG. 13 may additionally be implemented by combining at least the example microprocessor 1400 of FIG. 14 and the example FPGA circuitry 1500 of FIG. 15. In some such hybrid examples, one or more cores 1402 of FIG. 14 may execute a first portion of the machine-readable instructions represented by the flowchart(s) of FIGS. 9-12 to perform first operation(s)/function(s), the FPGA circuitry 1500 of FIG. 15 may be configured and/or structured to perform second operation(s)/function(s) corresponding to a second portion of the machine-readable instructions represented by the flowcharts of FIG. 9-12, and/or an ASIC may be configured and/or structured to perform third operation(s)/function(s) corresponding to a third portion of the machine-readable instructions represented by the flowcharts of FIGS. 9-12.

It should be understood that some or all of the circuitry of FIGS. 2 and/or 6 may, thus, be instantiated at the same or different times. For example, same and/or different portion(s) of the microprocessor 1400 of FIG. 14 may be programmed to execute portion(s) of machine-readable instructions at the same and/or different times. In some examples, same and/or different portion(s) of the FPGA circuitry 1500 of FIG. 15 may be configured and/or structured to perform operations/functions corresponding to portion(s) of machine-readable instructions at the same and/or different times.

In some examples, some or all of the circuitry of FIGS. 2 and/or 6 may be instantiated, for example, in one or more threads executing concurrently and/or in series. For example, the microprocessor 1400 of FIG. 14 may execute machine-readable instructions in one or more threads executing concurrently and/or in series. In some examples, the FPGA circuitry 1500 of FIG. 15 may be configured and/or structured to carry out operations/functions concurrently and/or in series. Moreover, in some examples, some or all of the circuitry of FIGS. 2 and/or 6 may be implemented within one or more virtual machines and/or containers executing on the microprocessor 1400 of FIG. 14.

In some examples, the programmable circuitry 1312 of FIG. 13 may be in one or more packages. For example, the microprocessor 1400 of FIG. 14 and/or the FPGA circuitry 1500 of FIG. 15 may be in one or more packages. In some examples, an XPU may be implemented by the programmable circuitry 1312 of FIG. 13, which may be in one or more packages. For example, the XPU may include a CPU (e.g., the microprocessor 1400 of FIG. 14, the CPU 1520 of FIG. 15, etc.) in one package, a DSP (e.g., the DSP 1522 of FIG. 15) in another package, a GPU in yet another package, and an FPGA (e.g., the FPGA circuitry 1500 of FIG. 15) in still yet another package.

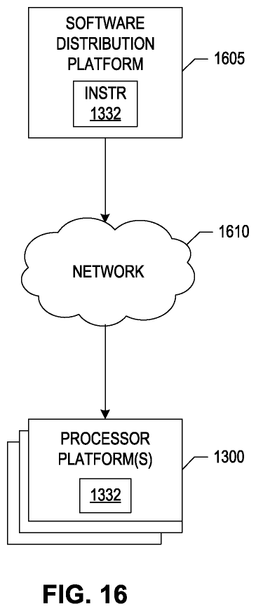

A block diagram illustrating an example software distribution platform 1605 to distribute software such as the example machine-readable instructions 1332 of FIG. 13 to other hardware devices (e.g., hardware devices owned and/or operated by third parties from the owner and/or operator of the software distribution platform) is illustrated in FIG. 16. The example software distribution platform 1605 may be implemented by any computer server, data facility, cloud service, etc., capable of storing and transmitting software to other computing devices. The third parties may be customers of the entity owning and/or operating the software distribution platform 1605. For example, the entity that owns and/or operates the software distribution platform 1605 may be a developer, a seller, and/or a licensor of software such as the example machine-readable instructions 1332 of FIG. 13. The third parties may be consumers, users, retailers, OEMs, etc., who purchase and/or license the software for use and/or re-sale and/or sub-licensing. In the illustrated example, the software distribution platform 1605 includes one or more servers and one or more storage devices. The storage devices store the machine-readable instructions 1332, which may correspond to the example machine-readable instructions of FIGS. 9-12, as described above. The one or more servers of the example software distribution platform 1605 are in communication with an example network 1610, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 1332 from the software distribution platform 1605. For example, the software, which may correspond to the example machine-readable instructions of FIG. 9-12, may be downloaded to the example programmable circuitry platform 1300, which is to execute the machine-readable instructions 1332 to implement the UMC circuitry 140. In some examples, one or more servers of the software distribution platform 1605 periodically offer, transmit, and/or force updates to the software (e.g., the example machine-readable instructions 1332 of FIG. 13) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that perform unified motion compensation processing for multiple video codecs. Disclosed systems, apparatus, articles of manufacture, and methods improve the efficiency of using a computing device by providing shared circuitry for implementing motion compensation for multiple supported video codecs, thereby reducing gate count and memory requirements relative to prior systems that implement different instances of motion compensation circuitry dedicated respectively to the multiple video codecs. Disclosed systems, apparatus, articles of manufacture, and methods are accordingly directed to one or more improvement(s) in the operation of a machine such as a computer or other electronic and/or mechanical device.

Further examples and combinations thereof include the following. Example 1 includes an apparatus comprising a plurality of dedicated video codec circuitry including first dedicated video codec circuitry associated with a first video coding standard and second dedicated video codec circuitry associated with a second video coding standard, and motion compensation circuitry coupled with the plurality of dedicated video codec circuitry, the motion compensation circuitry including reference data retrieval circuitry to identify a block of reference pixel data based on motion vector data and configuration data associated with an active one of the plurality of dedicated video codec circuitry, and filter circuitry to process the block of reference pixel data based on an active filter coefficient set selected from a plurality of stored filter coefficient sets based on the active one of the plurality of dedicated video codec circuitry, the stored filter coefficient sets including a first coefficient set associated with the first video coding standard and a second coefficient set associated with the second video coding standard.
Example 2 includes the apparatus of example 1, wherein the configuration data includes a frame scaling factor and a chroma format provided by the active one of the plurality of dedicated video codec circuitry.
Example 3 includes the apparatus of example 2, wherein the first dedicated video codec circuitry does not support frame scaling, and the first dedicated video codec circuitry is to set the frame scaling factor to a value of one when the first dedicated video codec circuitry is the active one of the plurality of dedicated video codec circuitry.
Example 4 includes the apparatus of any one of examples 1 to 3, wherein the reference data retrieval circuitry is to select the block of reference pixel data based on an encoded block of pixel data to be decoded, the encoded block of pixel data having a size of four (4) pixels by four (4) pixels.
Example 5 includes the apparatus of any one or example 1 to 4, including a cache to store cache lines of reference pixel data, wherein the reference data retrieval circuitry is to identify the cache lines of reference pixel data to be fetched from a frame of reference pixel data, and identify, based on the motion vector data and the configuration data, a location and a size of the block of reference pixel data in the cache lines of reference pixel data.
Example 6 includes the apparatus of example 5, wherein the cache includes circuitry to shift and replicate the cache lines of reference pixel data based on the location and the size of the block of reference pixel data to produce the block of reference pixel data to output to the filter circuitry.
Example 7 includes the apparatus of example 5, including a first-in-first-out (FIFO) buffer to store memory read requests for respective blocks of reference pixel data to be fetched into the cache, a size of the FIFO buffer based on a memory read latency.
Example 8 includes the apparatus of any one or example 1 to 7, wherein the plurality of stored filter coefficient sets includes a first plurality of filter coefficient sets dedicated to the first dedicated video codec circuitry and a second plurality of filter coefficient sets shared between the first dedicated video codec circuitry and the second dedicated video codec circuitry, the first plurality of filter coefficient sets associated with the first video coding standard, the second plurality of filter coefficient sets associated with both the first video coding standard and the second video coding standard.
Example 9 includes the apparatus of example 8, wherein the filter circuitry is to select the active filter coefficient set from a combination of the first plurality of filter coefficient sets and the second plurality of filter coefficient sets based on the first dedicated video codec circuitry being active, and select the active filter coefficient set from the second plurality of filter coefficient sets based on the second dedicated video codec circuitry being active.
Example 10 includes the apparatus of example 8, wherein the plurality of dedicated video codec circuitry includes third dedicated video codec circuitry associated with a third video coding standard, the plurality of stored filter coefficient sets includes a third plurality of filter coefficient sets dedicated to the third dedicated video codec circuitry and a fourth plurality of filter coefficient sets shared between the second dedicated video codec circuitry and the third dedicated video codec circuitry.
Example 11 includes the apparatus of example 10, wherein the second dedicated video codec circuitry is associated with the second video coding standard and a fourth video coding standard, and the filter circuitry is to select the active filter coefficient set from a combination of the first plurality of filter coefficient sets and the second plurality of filter coefficient sets based on the first dedicated video codec circuitry being active, select the active filter coefficient set from the second plurality of filter coefficient sets based on the second dedicated video codec circuitry being active and the second dedicated video codec circuitry being configured to implement the second video coding standard, select the active filter coefficient set from a combination of the third plurality of filter coefficient sets and the fourth plurality of filter coefficient sets based on the third dedicated video codec circuitry being active, and select the active filter coefficient set from the fourth plurality of filter coefficient sets based on the second dedicated video codec circuitry being active and the second dedicated video codec circuitry being configured to implement the fourth video coding standard.
Example 12 includes the apparatus of example 11, wherein the first video coding standard is a versatile video coding (VVC) standard, the second video coding standard is a high efficiency video coding (HEVC) standard, the third video coding standard is an Alliance for Open Media (AOMedia) video 1 (AV1) standard, and the fourth video coding standard is a video processing 9 (VP9) standard.
Example 13 includes the apparatus of any one or example 1 to 12, wherein the active filter coefficient set includes a horizontal filter coefficient set and a vertical filter coefficient set, and the filter circuitry includes a plurality of horizontal filter circuits to perform horizontal filtering of respective portions of the block of reference pixel data in parallel based on the horizontal filter coefficient set to produce a block of intermediate pixel data, and a plurality of vertical filter circuits to perform vertical filtering of respective portions of the block of horizontally filtered pixel data in parallel based on the vertical filter coefficient set to produce a block of filtered pixel data.
Example 14 includes the apparatus of example 13, wherein the filter circuitry includes circuitry to perform at least one of rounding or clipping of the filtered pixel data based on second configuration data associated with the active one of the plurality of dedicated video codec circuitry, the second configuration data including a shift value and an offset value associated with the active one of the plurality of dedicated video codec circuitry, the first dedicated video codec circuitry and the second dedicated video codec circuitry associated with different shift values and different offset values, and a buffer to store the second configuration data.
Example 15 includes at least one non-transitory computer-readable storage medium comprising computer-readable instructions to cause at least one programmable circuit to at least cause one of a plurality of dedicated video codec circuitry of a compute device to be active, the plurality of dedicated video codec circuitry including first dedicated video codec circuitry associated with a first video coding standard and second dedicated video codec circuitry associated with a second video coding standard, and cause configuration of motion compensation circuitry of the compute device to perform motion compensation operations for the active one of the plurality of dedicated video codec circuitry, the motion compensation circuitry shared among the plurality of dedicated video codec circuitry, the configuration based on configuration data associated with the active one of the plurality of dedicated video codec circuitry, the configuration data to cause the motion compensation circuitry to identify a block of reference pixel data based on motion vector data associated with the active one of the plurality of dedicated video codec circuitry, and process the block of reference pixel data based on an active filter coefficient set selected from a plurality of stored filter coefficient sets based on the active one of the plurality of dedicated video codec circuitry, the stored filter coefficient sets including a first coefficient set associated with the first video coding standard and a second coefficient set associated with the second video coding standard.
Example 16 includes the at least one non-transitory computer-readable storage medium of example 15, wherein the configuration data includes a frame scaling factor and a chroma format associated with the active one of the plurality of dedicated video codec circuitry, the motion compensation circuitry to identify the block of reference pixel data based on the motion vector data, the frame scaling factor and the chroma format, and the computer-readable instructions are to cause one or more of the at least one programmable circuit to determine whether the active one of the plurality of dedicated video codec circuitry supports frame scaling, and set the frame scaling factor to a value of one based on the active one of the plurality of dedicated video codec circuitry not supporting frame scaling.
Example 17 includes the at least one non-transitory computer-readable storage medium of example 16, wherein the configuration data includes a codec identifier to identify the active one of the plurality of dedicated video codec circuitry and a coding standard identifier to identify an active video coding standard implemented by the active one of the plurality of video codec circuitry, the motion compensation circuitry to select the active filter coefficient set from the plurality of stored filter coefficient sets based on the codec identifier and the coding standard identifier.
Example 18 includes a system comprising a plurality of video coding means for performing video codec operations associated with a plurality of video coding standards, the plurality of video coding means including first video coding means associated with a first video coding standard and second video coding means associated with a second video coding standard, and means for performing motion compensation for the plurality of video coding means, the means for performing motion compensation to identify a block of reference pixel data based on motion vector data and configuration data associated with an active one of the plurality of video coding means, and filter the block of reference pixel data based on an active filter coefficient set selected from a plurality of stored filter coefficient sets based on the active one of the plurality of video coding means, the stored filter coefficient sets including a first coefficient set associated with the first video coding standard and a second coefficient set associated with the second video coding standard.
Example 19 includes the system of example 18, wherein the plurality of stored filter coefficient sets includes a first plurality of filter coefficient sets dedicated to the first video coding means and a second plurality of filter coefficient sets shared between the first video coding means and the second video coding means, the first plurality of filter coefficient sets associated with the first video coding standard, the second plurality of filter coefficient sets associated with both the first video coding standard and the second video coding standard, and the means for performing motion compensation is to select the active filter coefficient set from a combination of the first plurality of filter coefficient sets and the second plurality of filter coefficient sets based on the first video coding means being active, and select the active filter coefficient set from the second plurality of filter coefficient sets based on the second video coding means being active.
Example 20 includes the system of example 18 or example 19, wherein the active filter coefficient set includes a horizontal filter coefficient set and a vertical filter coefficient set, and the means for performing motion compensation is to perform horizontal filtering of respective portions of the block of reference pixel data in parallel based on the horizontal filter coefficient set to produce a block of intermediate pixel data, perform vertical filtering of respective portions of the block of horizontally filtered pixel data in parallel based on the vertical filter coefficient set to produce a block of filtered pixel data, and perform at least one of rounding or clipping of the filtered pixel data based on the configuration data associated with the active one of the plurality of video coding means, the configuration data including a shift value and an offset value associated with the active one of the plurality of video coding means, the plurality of video coding means associated with different shift values and different offset values.
Example 21 includes a method comprising identifying a block of reference pixel data based on motion vector data and configuration data associated with an active one of a plurality of dedicated video codec circuitry, the plurality of dedicated video codec circuitry including first dedicated video codec circuitry associated with a first video coding standard and second dedicated video codec circuitry associated with a second video coding standard, and processing the block of reference pixel data based on an active filter coefficient set selected from a plurality of stored filter coefficient sets based on the active one of the plurality of dedicated video codec circuitry, the stored filter coefficient sets including a first coefficient set associated with the first video coding standard and a second coefficient set associated with the second video coding standard.
Example 22 includes the method of example 21, wherein the configuration data includes a frame scaling factor and a chroma format provided by the active one of the plurality of dedicated video codec circuitry.
Example 23 includes the method of example 22, wherein the first dedicated video codec circuitry does not support frame scaling, and including setting the frame scaling factor to a value of one when the first dedicated video codec circuitry is the active one of the plurality of dedicated video codec circuitry.
Example 24 includes the method of any one of examples 21 to 23, including selecting the block of reference pixel data based on an encoded block of pixel data to be decoded, the encoded block of pixel data having a size of four (4) pixels by four (4) pixels.
Example 25 includes the method of any one or example 21 to 24, including identifying cache lines of reference pixel data to be fetched from a frame of reference pixel data, and identifying, based on the motion vector data and the configuration data, a location and a size of the block of reference pixel data in the cache lines of reference pixel data.
Example 26 includes the method of example 25, including shifting and replicating the cache lines of reference pixel data based on the location and the size of the block of reference pixel data to produce the block of reference pixel data.
Example 27 includes the method of example 25, including storing, in a first-in-first-out (FIFO) buffer, memory read requests for respective blocks of reference pixel data to be fetched into the cache, a size of the FIFO buffer based on a memory read latency.
Example 28 includes the method of any one or example 21 to 27, wherein the plurality of stored filter coefficient sets includes a first plurality of filter coefficient sets dedicated to the first dedicated video codec circuitry and a second plurality of filter coefficient sets shared between the first dedicated video codec circuitry and the second dedicated video codec circuitry, the first plurality of filter coefficient sets associated with the first video coding standard, the second plurality of filter coefficient sets associated with both the first video coding standard and the second video coding standard.
Example 29 includes the method of example 28, including selecting the active filter coefficient set from a combination of the first plurality of filter coefficient sets and the second plurality of filter coefficient sets based on the first dedicated video codec circuitry being active, and selecting the active filter coefficient set from the second plurality of filter coefficient sets based on the second dedicated video codec circuitry being active.
Example 30 includes the method of example 28, wherein the plurality of dedicated video codec circuitry includes third dedicated video codec circuitry associated with a third video coding standard, the plurality of stored filter coefficient sets includes a third plurality of filter coefficient sets dedicated to the third dedicated video codec circuitry and a fourth plurality of filter coefficient sets shared between the second dedicated video codec circuitry and the third dedicated video codec circuitry.
Example 31 includes the method of example 30, wherein the second dedicated video codec circuitry is associated with the second video coding standard and a fourth video coding standard, and including selecting the active filter coefficient set from a combination of the first plurality of filter coefficient sets and the second plurality of filter coefficient sets based on the first dedicated video codec circuitry being active, selecting the active filter coefficient set from the second plurality of filter coefficient sets based on the second dedicated video codec circuitry being active and the second dedicated video codec circuitry being configured to implement the second video coding standard, selecting the active filter coefficient set from a combination of the third plurality of filter coefficient sets and the fourth plurality of filter coefficient sets based on the third dedicated video codec circuitry being active, and selecting the active filter coefficient set from the fourth plurality of filter coefficient sets based on the second dedicated video codec circuitry being active and the second dedicated video codec circuitry being configured to implement the fourth video coding standard.
Example 32 includes the method of example 31, wherein the first video coding standard is a versatile video coding (VVC) standard, the second video coding standard is a high efficiency video coding (HEVC) standard, the third video coding standard is an Alliance for Open Media (AOMedia) video 1 (AV1) standard, and the fourth video coding standard is a video processing 9 (VP9) standard.
Example 33 includes the method of any one or example 21 to 32, wherein the active filter coefficient set includes a horizontal filter coefficient set and a vertical filter coefficient set, and including performing horizontal filtering of respective portions of the block of reference pixel data in parallel based on the horizontal filter coefficient set to produce a block of intermediate pixel data, and performing vertical filtering of respective portions of the block of horizontally filtered pixel data in parallel based on the vertical filter coefficient set to produce a block of filtered pixel data.
Example 34 includes the method of example 33, including performing at least one of rounding or clipping of the filtered pixel data based on second configuration data associated with the active one of the plurality of dedicated video codec circuitry, the second configuration data including a shift value and an offset value associated with the active one of the plurality of dedicated video codec circuitry, the first dedicated video codec circuitry and the second dedicated video codec circuitry associated with different shift values and different offset values, and storing the second configuration data in a buffer.
Example 35 includes at least one machine-readable medium comprising machine-readable instructions to cause at least one programmable circuit to perform the method of any one of examples 21 to example 34.
Example 36 includes an apparatus to perform the method of any one of examples 21 to example 34.
Example 37 includes a method performed by any one of the apparatus of examples 1 to example 14.
Example 38 includes At least one machine-readable medium comprising the machine-readable instructions of any one of the apparatus of examples 1 to example 14.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
a plurality of dedicated video codec circuitry including first dedicated video codec circuitry associated with a first video coding standard and second dedicated video codec circuitry associated with a second video coding standard; and
motion compensation circuitry coupled with the plurality of dedicated video codec circuitry, the motion compensation circuitry including:
reference data retrieval circuitry to identify a block of reference pixel data based on motion vector data and configuration data associated with an active one of the plurality of dedicated video codec circuitry; and
filter circuitry to process the block of reference pixel data based on an active filter coefficient set selected from a plurality of stored filter coefficient sets based on the active one of the plurality of dedicated video codec circuitry, the stored filter coefficient sets including a first coefficient set associated with the first video coding standard and a second coefficient set associated with the second video coding standard.

2. The apparatus of claim 1, wherein the configuration data includes a frame scaling factor and a chroma format provided by the active one of the plurality of dedicated video codec circuitry.

3. The apparatus of claim 2, wherein the first dedicated video codec circuitry does not support frame scaling, and the first dedicated video codec circuitry is to set the frame scaling factor to a value of one when the first dedicated video codec circuitry is the active one of the plurality of dedicated video codec circuitry.

4. The apparatus of claim 1, wherein the reference data retrieval circuitry is to select the block of reference pixel data based on an encoded block of pixel data to be decoded, the encoded block of pixel data having a size of four (4) pixels by four (4) pixels.

5. The apparatus of claim 1, including a cache to store cache lines of reference pixel data, wherein the reference data retrieval circuitry is to:
identify the cache lines of reference pixel data to be fetched from a frame of reference pixel data; and
identify, based on the motion vector data and the configuration data, a location and a size of the block of reference pixel data in the cache lines of reference pixel data.

6. The apparatus of claim 5, wherein the cache includes circuitry to shift and replicate the cache lines of reference pixel data based on the location and the size of the block of reference pixel data to produce the block of reference pixel data to output to the filter circuitry.

7. The apparatus of claim 5, including a first-in-first-out (FIFO) buffer to store memory read requests for respective blocks of reference pixel data to be fetched into the cache, a size of the FIFO buffer based on a memory read latency.

8. The apparatus of claim 1, wherein the plurality of stored filter coefficient sets includes a first plurality of filter coefficient sets dedicated to the first dedicated video codec circuitry and a second plurality of filter coefficient sets shared between the first dedicated video codec circuitry and the second dedicated video codec circuitry, the first plurality of filter coefficient sets associated with the first video coding standard, the second plurality of filter coefficient sets associated with both the first video coding standard and the second video coding standard.

9. The apparatus of claim 8, wherein the filter circuitry is to:
select the active filter coefficient set from a combination of the first plurality of filter coefficient sets and the second plurality of filter coefficient sets based on the first dedicated video codec circuitry being active; and
select the active filter coefficient set from the second plurality of filter coefficient sets based on the second dedicated video codec circuitry being active.

10. The apparatus of claim 8, wherein the plurality of dedicated video codec circuitry includes third dedicated video codec circuitry associated with a third video coding standard, the plurality of stored filter coefficient sets includes a third plurality of filter coefficient sets dedicated to the third dedicated video codec circuitry and a fourth plurality of filter coefficient sets shared between the second dedicated video codec circuitry and the third dedicated video codec circuitry.

11. The apparatus of claim 10, wherein the second dedicated video codec circuitry is associated with the second video coding standard and a fourth video coding standard, and the filter circuitry is to:
select the active filter coefficient set from a combination of the first plurality of filter coefficient sets and the second plurality of filter coefficient sets based on the first dedicated video codec circuitry being active;
select the active filter coefficient set from the second plurality of filter coefficient sets based on the second dedicated video codec circuitry being active and the second dedicated video codec circuitry being configured to implement the second video coding standard;
select the active filter coefficient set from a combination of the third plurality of filter coefficient sets and the fourth plurality of filter coefficient sets based on the third dedicated video codec circuitry being active; and
select the active filter coefficient set from the fourth plurality of filter coefficient sets based on the second dedicated video codec circuitry being active and the second dedicated video codec circuitry being configured to implement the fourth video coding standard.

12. The apparatus of claim 11, wherein the first video coding standard is a versatile video coding (VVC) standard, the second video coding standard is a high efficiency video coding (HEVC) standard, the third video coding standard is an Alliance for Open Media (AOMedia) video 1 (AV1) standard, and the fourth video coding standard is a video processing 9 (VP9) standard.

13. The apparatus of claim 1, wherein the active filter coefficient set includes a horizontal filter coefficient set and a vertical filter coefficient set, and the filter circuitry includes:
a plurality of horizontal filter circuits to perform horizontal filtering of respective portions of the block of reference pixel data in parallel based on the horizontal filter coefficient set to produce a block of intermediate pixel data; and
a plurality of vertical filter circuits to perform vertical filtering of respective portions of the block of horizontally filtered pixel data in parallel based on the vertical filter coefficient set to produce a block of filtered pixel data.

14. The apparatus of claim 13, wherein the filter circuitry includes circuitry to:
perform at least one of rounding or clipping of the filtered pixel data based on second configuration data associated with the active one of the plurality of dedicated video codec circuitry, the second configuration data including a shift value and an offset value associated with the active one of the plurality of dedicated video codec circuitry, the first dedicated video codec circuitry and the second dedicated video codec circuitry associated with different shift values and different offset values; and
a buffer to store the second configuration data.

15. At least one non-transitory computer-readable storage medium comprising computer-readable instructions to cause at least one programmable circuit to at least:
cause one of a plurality of dedicated video codec circuitry of a compute device to be active, the plurality of dedicated video codec circuitry including first dedicated video codec circuitry associated with a first video coding standard and second dedicated video codec circuitry associated with a second video coding standard; and
cause configuration of motion compensation circuitry of the compute device to perform motion compensation operations for the active one of the plurality of dedicated video codec circuitry, the motion compensation circuitry shared among the plurality of dedicated video codec circuitry, the configuration based on configuration data associated with the active one of the plurality of dedicated video codec circuitry, the configuration data to cause the motion compensation circuitry to identify a block of reference pixel data based on motion vector data associated with the active one of the plurality of dedicated video codec circuitry, and process the block of reference pixel data based on an active filter coefficient set selected from a plurality of stored filter coefficient sets based on the active one of the plurality of dedicated video codec circuitry, the stored filter coefficient sets including a first coefficient set associated with the first video coding standard and a second coefficient set associated with the second video coding standard.

16. The at least one non-transitory computer-readable storage medium of claim 15, wherein the configuration data includes a frame scaling factor and a chroma format associated with the active one of the plurality of dedicated video codec circuitry, the motion compensation circuitry to identify the block of reference pixel data based on the motion vector data, the frame scaling factor and the chroma format, and the computer-readable instructions are to cause one or more of the at least one programmable circuit to:
determine whether the active one of the plurality of dedicated video codec circuitry supports frame scaling; and
set the frame scaling factor to a value of one based on the active one of the plurality of dedicated video codec circuitry not supporting frame scaling.

17. The at least one non-transitory computer-readable storage medium of claim 16, wherein the configuration data includes a codec identifier to identify the active one of the plurality of dedicated video codec circuitry and a coding standard identifier to identify an active video coding standard implemented by the active one of the plurality of video codec circuitry, the motion compensation circuitry to select the active filter coefficient set from the plurality of stored filter coefficient sets based on the codec identifier and the coding standard identifier.

18. A system comprising:
a plurality of video coding means for performing video codec operations associated with a plurality of video coding standards, the plurality of video coding means including first video coding means associated with a first video coding standard and second video coding means associated with a second video coding standard; and
means for performing motion compensation for the plurality of video coding means, the means for performing motion compensation to:
identify a block of reference pixel data based on motion vector data and configuration data associated with an active one of the plurality of video coding means; and
filter the block of reference pixel data based on an active filter coefficient set selected from a plurality of stored filter coefficient sets based on the active one of the plurality of video coding means, the stored filter coefficient sets including a first coefficient set associated with the first video coding standard and a second coefficient set associated with the second video coding standard.

19. The system of claim 18, wherein the plurality of stored filter coefficient sets includes a first plurality of filter coefficient sets dedicated to the first video coding means and a second plurality of filter coefficient sets shared between the first video coding means and the second video coding means, the first plurality of filter coefficient sets associated with the first video coding standard, the second plurality of filter coefficient sets associated with both the first video coding standard and the second video coding standard, and the means for performing motion compensation is to:
select the active filter coefficient set from a combination of the first plurality of filter coefficient sets and the second plurality of filter coefficient sets based on the first video coding means being active; and
select the active filter coefficient set from the second plurality of filter coefficient sets based on the second video coding means being active.

20. The system of claim 18, wherein the active filter coefficient set includes a horizontal filter coefficient set and a vertical filter coefficient set, and the means for performing motion compensation is to:
perform horizontal filtering of respective portions of the block of reference pixel data in parallel based on the horizontal filter coefficient set to produce a block of intermediate pixel data;
perform vertical filtering of respective portions of the block of horizontally filtered pixel data in parallel based on the vertical filter coefficient set to produce a block of filtered pixel data; and
perform at least one of rounding or clipping of the filtered pixel data based on the configuration data associated with the active one of the plurality of video coding means, the configuration data including a shift value and an offset value associated with the active one of the plurality of video coding means, the plurality of video coding means associated with different shift values and different offset values.
